(19) United States
(12) Patent Application Publication
(10) Pub. No.: US 2014/0040005 A1
(43) Pub. Date: Feb. 6, 2014

(54) SYSTEM AND METHOD FOR SELECTIVELY PROVIDING VIRTUAL BOUNCE BACK COUPONS

(71) Applicant: Meijer, Inc., Grand Rapids, MI (US)

(72) Inventors: Bhushan Balani, Ada, MI (US); Andrew Powell, Grand Rapids, MI (US); Shrineil Patel, Grand Rapids, MI (US)

(73) Assignee: Meijer, Inc., Grand Rapids, MI (US)

(21) Appl. No.: 13/957,630

(22) Filed: Aug. 2, 2013

Related U.S. Application Data
(60) Provisional application No. 61/679,195, filed on Aug. 3, 2012.

(51) Int. Cl. G06Q 30/02

(52) U.S. Cl. CPC G06Q 30/0239
USPC 705/14.39; 705/14.26

(57) ABSTRACT

A system for providing virtual coupons to a customer illustratively includes a database having a plurality of virtual coupons stored therein, a virtual coupon repository associated with the customer, and a virtual coupon module to transfer a sequence of selected ones of the plurality of virtual coupons stored in the database to the virtual coupon repository, and to sequentially activate for redemption by the customer each successive virtual coupon in the sequence after a preceding virtual coupon in the sequence has been redeemed by the customer.

### CROSS-REFERENCE TO RELATED APPLICATION

This patent application claims the benefit of, and priority to, U.S. Provisional Patent Application Ser. No. 61/679,195, filed Aug. 3, 2012, the disclosure of which is incorporated herein by reference.

### BACKGROUND

Retailers of goods and services may typically offer such goods and services for purchase via one or more conventional brick-and-mortar retail outlets. Such retail outlets may include any number of point-of-sale systems via which customers purchase items selected while shopping according to a so-called “checkout” process. Retailers may additionally or alternatively operate one or more on-line services via which customers may purchase items.

Retailers may further offer virtual coupons to customers, and such virtual coupons may be stored in a database and accessed by customers via a virtual customer coupon service to automatically redeem the virtual coupons during purchase of goods and/or services. Such virtual coupons thus provide an economic benefit to customers who shop at the retailer.

### SUMMARY

This disclosure may comprise one or more of the features recited in the attached claims, and/or one or more of the following features and combinations thereof. In one aspect, a system for providing virtual coupons to a customer may include a database having a plurality of virtual coupons stored therein, a virtual coupon repository associated with the customer, and a virtual coupon module to transfer a sequence of selected ones of the plurality of virtual coupons stored in the database to the virtual coupon repository, and to sequentially activate for redemption by the customer each successive virtual coupon in the sequence after a preceding virtual coupon in the sequence has been redeemed by the customer.

Each of the database, the virtual coupon repository and the virtual coupon module may be contained within or accessible by a server operated by a retail enterprise, the server to control operation of the virtual coupon module.

The virtual coupon module may sequentially activate for redemption by the customer each virtual coupon in the sequence by activating a first virtual coupon in the sequence for redemption by the customer during or following transfer of the sequence of the selected ones of the plurality of virtual coupons stored in the database to the virtual coupon repository, and thereafter by sequentially activating for redemption by the customer a next successive virtual coupon in the sequence following redemption by the customer of a preceding virtual coupon in the sequence.

The virtual coupon module may notify the customer upon or following activation of at least one of the virtual coupons in the sequence by the virtual coupon module.

The system described in any one or more of the preceding paragraphs of this SUMMARY may include a user computing device having a processor coupled to a display monitor and to a memory having stored therein instructions executable by the processor to control the display monitor to display thereon each of the sequence of selected ones of the plurality of virtual coupons contained in the virtual coupon repository that are configured to be displayed to the customer. The virtual coupon module may configure a currently active one of the sequence of selected ones of the plurality of virtual coupons contained in the virtual coupon repository to be displayed to the customer as an active and redeemable coupon. Alternatively or additionally, the virtual coupon module may configure remaining ones of the sequence of selected ones of the plurality of virtual coupons contained in the virtual coupon repository to be one of displayed to the customer as inactive and not redeemable and hidden from display to the customer. Alternatively or additionally still, the virtual coupon module may delete each virtual coupon in the sequence from the virtual coupon repository after redemption thereof by the customer.

The system described in any one or more of the preceding paragraphs of this SUMMARY may further include a point-of-sale system having a processor coupled to a memory having stored therein instructions executable by the processor to process one or more items selected for purchase by the customer, to compare a currently active one of the sequence of selected ones of the plurality of virtual coupons contained in the virtual coupon repository with the one or more items selected for purchase by the customer and to redeem the currently active one of the virtual coupons contained in the virtual coupon repository if the currently active one of the virtual coupons contained in the virtual coupon repository matches one of the one or more items selected for purchase by the customer.

In the system described in any one or more of the preceding paragraphs of this SUMMARY, the sequence of selected ones of the plurality of virtual coupons transferred to the virtual coupon repository may define a first sequence of virtual coupons, and the virtual coupon module may transfer a selected parent virtual coupon from the plurality of virtual coupons stored in the database to the virtual coupon repository, transfer a second sequence of selected ones of the plurality of virtual coupons stored in the database to the virtual coupon repository, and link the parent virtual coupon in the virtual coupon repository to first virtual coupons in each of the first and second sequences of virtual coupons. The virtual coupon module may initially activate for redemption only the parent virtual coupon. The virtual coupon module may activate for redemption the first virtual coupon in one of the first and second sequences of virtual coupons selected by the customer following redemption of the parent virtual coupon by the customer, and the virtual coupon module may sequentially activate for redemption by the customer each virtual coupon in the one of the first and second sequences selected by the customer after a preceding virtual customer coupon in the one of the first and second selected sequences selected by the customer has been redeemed by the customer. The virtual coupon module may delete from the virtual coupon repository the one of the first and second sequences of virtual coupons not selected by the customer following redemption of the parent virtual coupon by the customer. The system described in this paragraph may further include a user computing device having a processor coupled to a display monitor and to a memory having stored therein instructions executable by the processor to control the display monitor to display thereon each virtual coupon contained in the virtual coupon repository that is configured to be displayed to the customer, and the virtual coupon module may configure the parent virtual coupon to be displayed to the customer as an active and redeemable coupon and may configure at least the first virtual coupons in each of the first and second sequences of virtual coupons to be displayed to the customer, when or after the parent virtual coupon is initially activated for redemption. The virtual coupon module may display instructions in the virtual coupon repository, at least one of following initial activation of the virtual parent coupon for redemption and following redemption by the customer of the virtual parent coupon, to select one of the first and second sequences of virtual coupons to be sequentially redeemed by the customer following redemption of the parent virtual coupon by the customer and, following customer selection of the one of the first and second sequences of virtual coupons, the virtual coupon module may activate the first virtual coupon in the customer selected one of the first and second sequences of virtual coupons for subsequent redemption by the customer, configure the first virtual coupon in the customer selected one of the first and second sequences of virtual coupons to be displayed to the customer as an active and redeemable virtual coupon, and sequentially activate for redemption by the customer and configure to be displayed to the customer as an active and redeemable virtual coupon each successive virtual coupon in the customer selected one of the first and second sequences of virtual coupons after a preceding virtual customer coupon in the customer selected one of the first and second selected sequences of virtual coupons has been redeemed by the customer. Following customer redemption of the one of the first and second sequences of virtual coupons, the virtual coupon module may delete the other of the first and second sequences of virtual coupons from the virtual coupon repository.

A method of providing virtual coupons to a customer may include transferring a sequence of selected ones of a plurality of virtual coupons stored in a database to a virtual coupon repository, and sequentially activating for redemption by the customer each successive virtual coupon in the sequence after a preceding virtual coupon in the sequence has been redeemed by the customer.

Sequentially activating for redemption by the customer each virtual coupon in the sequence may include activating a first virtual coupon in the sequence for redemption by the customer during or following transfer of the sequence of the selected ones of the plurality of virtual coupons stored in the database to the virtual coupon repository, and thereafter sequentially activating for redemption by the customer a next successive virtual coupon in the sequence following redemption by the customer of a preceding virtual coupon in the sequence. Alternatively or additionally, the virtual coupon module may configure a currently active one of the sequence of selected ones of the plurality of virtual coupons contained in the virtual coupon repository to be displayed to the customer as an active and redeemable coupon, and may configure remaining ones of the sequence of selected ones of the plurality of virtual coupons contained in the virtual coupon repository to be one of displayed to the customer as inactive and not redeemable and hidden from display to the customer. Alternatively or additionally still, the method may further include deleting each virtual coupon in the sequence from the virtual coupon repository after redemption thereof by the customer.

A system for providing virtual coupons to a customer may include a database having a plurality of virtual coupons stored therein, each of the plurality of virtual coupons having one or more identification tags, a virtual coupon repository associated with the customer, and a virtual coupon module to transfer a selected one of the plurality of virtual coupons stored in the database to the virtual coupon repository for redemption by the customer, and to replace the selected one of the plurality of virtual coupons in the virtual coupon repository with one of the remaining virtual coupons in the plurality of virtual coupons following redemption by the customer of the selected one of the plurality of virtual coupons, the one of the remaining virtual coupons having at least one identification tag in common with at least one identification tag of the selected one of the plurality of virtual coupons.

The virtual coupon module may repeatedly replace a current one of the plurality of virtual coupons in the virtual coupon repository with another one of the remaining virtual coupons following redemption by the customer of the current one of the plurality of virtual coupons, the another one of the remaining virtual coupons having at least one identification tag in common with at least one identification tag of the current one of the plurality of virtual coupons. Alternatively or additionally, the virtual coupon module, in at least one replacement of the current one of the plurality of virtual coupons, may replace the current one of plurality of virtual coupons in the virtual coupon repository with another one of the remaining virtual coupons by transferring a subset of the remaining virtual coupons into the virtual coupon repository following redemption by the customer of the current one of the plurality of virtual coupons, and replacing the current one of plurality of virtual coupons in the virtual coupon repository with a selected one of the subset of the remaining virtual coupons.

In the system described in either of the two preceding paragraphs, the plurality of virtual coupons may define a set of virtual coupons each having in common at least one of the one or more identification tags, the virtual coupon module may transfer the selected one of the plurality of virtual coupons to the virtual coupon repository by transferring a selected one of the set of virtual coupons into the virtual coupon repository, and the virtual coupon module may replace the selected one of the plurality of virtual coupons in the virtual coupon repository by replacing the selected one of the set of virtual coupons in the virtual coupon repository with one of the remaining virtual coupons in the set of virtual coupons following redemption by the customer of the selected one of the set of virtual coupons. The virtual coupon module may repeatedly replace a current one of set of virtual coupons in the virtual coupon repository with another one of the remaining virtual coupons in the set of virtual coupons following redemption by the customer of the current one of the set of virtual coupons. Alternatively or additionally, the virtual coupon module may replace the current one of the set of virtual coupons in the virtual coupon repository with another one of the remaining virtual coupons in the set of virtual coupons by transferring a subset of the set of virtual coupons into the virtual coupon repository following redemption by the customer of the current one of the set of virtual coupons, and replacing the current one of set of virtual coupons in the virtual coupon repository with a selected one of the subset of the remaining virtual coupons in the set of virtual coupons.

A method of providing virtual coupons to a customer may include transferring a selected one of a plurality of virtual coupons stored in a database to a virtual coupon repository for redemption by the customer, each of the plurality of virtual coupons having one or more identification tags, and replacing the selected one of the plurality of virtual coupons in the virtual coupon repository with one of the remaining virtual coupons in the plurality of virtual coupons following redemption by the customer of the selected one of the plurality of virtual coupons, the one of the remaining virtual coupons having at least one identification tag in common with at least one identification tag of the selected one of the plurality of virtual coupons.

The method may further include repeatedly replacing a current one of the plurality of virtual coupons in the virtual coupon repository with another one of the remaining virtual coupons following redemption by the customer of the current one of the plurality of virtual coupons, the another one of the remaining virtual coupons having at least one identification tag in common with at least one identification tag of the current one of the plurality of virtual coupons. Alternatively or additionally, at least one instance of replacing the current one of plurality of virtual coupons in the virtual coupon repository with another one of the remaining virtual coupons may include transferring a subset of the remaining virtual coupons into the virtual coupon repository following redemption by the customer of the current one of the plurality of virtual coupons, and replacing the current one of plurality of virtual coupons in the virtual coupon repository with a selected one of the subset of the remaining virtual coupons.

In the method described in either of the two preceding paragraphs, the plurality of virtual coupons may define a set of virtual coupons each having in common at least one of the one or more identification tags, transferring the selected one of the plurality of virtual coupons to the virtual coupon repository may include transferring a selected one of the set of virtual coupons into the virtual coupon repository, and replacing the selected one of the plurality of virtual coupons in the virtual coupon repository may include replacing the selected one of the set of virtual coupons in the virtual coupon repository with one of the remaining virtual coupons following redemption by the customer of the selected one of the set of virtual coupons.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for selectively providing virtual bounce back coupons for customer use at a retail enterprise.

FIG. 2 is a simplified block diagram of an embodiment of one of the point-of-sale systems illustrated in FIG. 1.

FIG. 3 is a simplified block diagram of an embodiment of one of the user computing devices illustrated in FIG. 1.

FIG. 4 is a simplified block diagram of an embodiment of an environment of the main server of FIG. 1.

FIG. 5 is a simplified flow diagram of at least one embodiment of a process for selectively providing virtual bounce back coupons for customer use at a retail enterprise.

FIG. 6 is a simplified block diagram of an embodiment of a virtual customer coupon repository within the server database of the main server, as viewed on a display monitor of one of the user computing devices of FIG. 1, showing an example storage and display of a selected sequence of virtual coupons offered to the customer.

FIG. 7 is a simplified block diagram of the virtual customer coupon repository illustrated in FIG. 6 modified to show an alternate storage and display of the selected sequence of virtual coupons offered to the customer.

FIG. 8 is a simplified flow diagram of at least one embodiment of a process for automatically redeeming one or more virtual coupons as customers purchase one or more corresponding items at one of the point-of-sale systems illustrated in FIG. 1.

FIG. 9 is a simplified flow diagram of at least one embodiment of a process for selectively providing a plurality of virtual coupon sequence options for selection by a customer according to an embodiment of the routine A illustrated in FIG. 5.

FIG. 10 is a simplified block diagram of an embodiment of a virtual customer coupon repository within the server database of the main server, as viewed on a display monitor of one of the user computing devices of FIG. 1, showing an example storage and display of a plurality of customer-selectable sequences of virtual coupons each linked to a single parent virtual coupon offered to the customer.

FIG. 11 is a simplified flow diagram of at least one alternate embodiment of a process for selectively providing virtual bounce back coupons for customer use at a retail enterprise.

FIG. 12 is a simplified flow diagram of at least one embodiment of a process for selectively replacing a redeemed virtual coupon in a virtual customer coupon repository with a new virtual coupon according to an embodiment of the routine B illustrated in FIG. 11.

FIG. 13 is a simplified flow diagram of at least one embodiment of a process for selectively replacing a redeemed virtual coupon in a virtual customer coupon repository with a customer-selected one of a subset of virtual coupons according to an alternate embodiment of the routine B illustrated in FIG. 11.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, resource partitioning/sharing/duplication implementations, types and interrelationships of system components, and logic partitioning/integration choices are set forth in order to provide a more thorough understanding of the present disclosure. Control structures, gate level circuits, driver circuits and full software instruction sequences have not been shown in detail in order not to obscure the invention. It will be appreciated, however, by one skilled in the art that embodiments of the disclosure may be practiced without such specific details. Those of ordinary skill in the art, with the included descriptions, will be able to implement appropriate functionality without undue experimentation.

References in the specification to “one embodiment”, “an embodiment”, “an example embodiment”, “one illustrative embodiment” etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred. The terms “customer,” “shopper” and “user,” and variants thereof, are used interchangeably in the following description, and such terms should be understood to refer interchangeably to an individual or a predefined group of individuals, e.g., members of a family, employees of a common business entity, etc., who shops at and purchases items from a retail enterprise.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

The term “virtual coupon” (and/or “virtual customer coupon”) is defined for purposes of this disclosure as a discount coupon stored in a memory device in the form of data, information and/or instructions which may be accessed from, re-stored in and/or deleted from a memory by a processor, and which may be manipulated and/or processed by a processor to determine information relating to one or more items to be purchased, examples of which information may include, but should not be limited to, item identification information, item family identification information, item discount amount, in one or more forms and/or types of currency, minimum and/or maximum item quantities subject to the item discount amount, beginning and/or expiration date of the item discount amount, and the like. The term “sequence of virtual coupons” is defined for purposes of this disclosure as a linked series of two or more virtual coupons, as the term “virtual coupon” is defined herein, such that the sequence of virtual coupons has a first virtual coupon in the sequence that is accessible, and that must be redeemed, by a customer before any other virtual coupons in the sequence of virtual coupons, a last virtual coupon that is accessible and that cannot be redeemed, by the customer until all others in the sequence have been redeemed, and zero or any positive integer number of sequentially accessible and redeemable coupons between the first and last virtual coupons in the sequence.

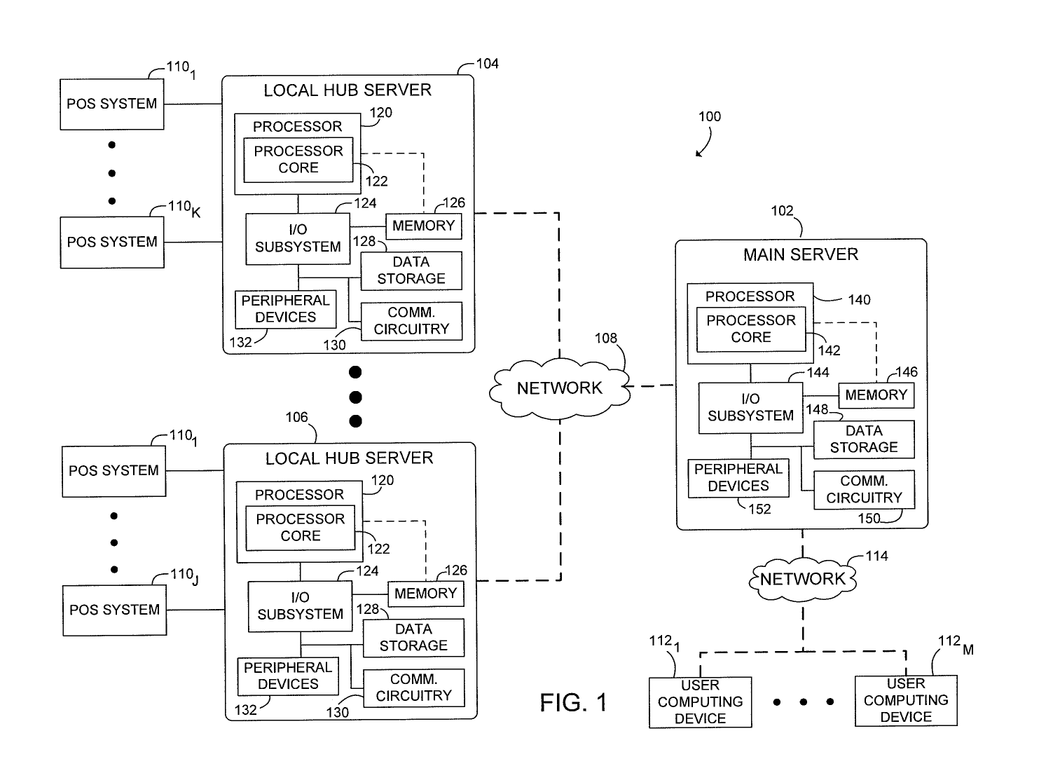

Referring now to FIG. 1, a system 100 is shown for selectively providing virtual bounce back coupons for customer use at a retail enterprise. In the illustrated embodiment, the system 100 includes a main server 102 coupled via a network 108 to a plurality of local hub servers 104, 106 each coupled to one or more point-of-sale systems 110₁-110_{K}, 110₁-110_{J}, and each of the point-of-sale systems 110₁-110_{K}, 110₁-110_{J} is configured to process items selected by customers for purchase and to process payment for such items. As discussed in more detail below, the main server 102 includes or otherwise has access to a database, and at least a portion of the database contains a plurality of virtual customer coupon repositories each configured to store and manage virtual coupons for a different one of a corresponding plurality of customers of the retail enterprise. In this regard, the main server 102 may be communicatively coupled at any one time to any number of user computing devices 112₁-112_{M} via a publicly accessible network 114, and customers having virtual customer coupon repositories may use one or more of the user computing devices 112₁-112_{M} to access and manage such repositories via the network 114.

The main server 102 further includes a virtual coupon module which is configured to selectively offer one or more sequences of virtual coupons to any of the plurality of customers by selectively transferring such one or more sequences of virtual coupons, in whole or in part, from a virtual coupon database to any of the plurality of virtual customer coupon repositories. In one embodiment, for example, the virtual coupon module may be configured to select from the virtual coupon database, or a subset thereof, a sequence of virtual coupons to offer to a customer, to transfer the selected sequence of virtual coupons, in whole or in part, to that customer's virtual customer coupon repository in the main server database, to initially make available for redemption by the customer only the first virtual coupon in the sequence of virtual coupons and to thereafter sequentially make available for redemption by the customer each of the virtual coupons in the sequence such that the customer may only redeem a virtual coupon in the sequence after all preceding virtual coupons in the sequence have been redeemed. In some embodiments, the virtual coupon module may link a plurality of sequences of virtual coupons to a single parent virtual coupon, and a customer may then be required to select only one of the plurality of sequences of virtual coupons for subsequent sequential redemption following redemption of the parent virtual coupon.

In still other embodiments, the virtual coupon module may be configured to dynamically select and transfer virtual coupons from the virtual coupon database, or a subset thereof, to one or more of the virtual customer coupon repositories, such that the sequence of virtual coupons is formed dynamically as customers redeem the virtual coupons in the sequence. For example, the virtual coupon module may be configured in this embodiment to select a next virtual coupon from the virtual coupon database, or subset thereof, to offer to a customer only after the customer redeems a virtual coupon currently accessible by the customer in that customer's virtual customer coupon repository. Alternatively or additionally, the virtual coupon module may be configured in this embodiment to dynamically select a plurality of next virtual coupons from the virtual coupon database, or subset thereof, to offer to a customer after the customer redeems a virtual coupon currently accessible by the customer in that customer's virtual customer coupon repository, and the customer must then choose a virtual coupon to redeem from among the dynamically selected plurality of next virtual coupons. In any case, the virtual coupon module may be configured to select one or any sequence of virtual coupons to offer to one or more customers each having a virtual customer coupon repository based on one virtual coupon offer criterion or on a plurality of virtual coupon offer criteria. Examples of the virtual coupon offer criterion or criteria may include, but should not be limited to, all such customers, a random selection of such customers, one or more subgroups of customers sharing at least one common trait, e.g., age, gender, letter of first and/or last name, geographical location of residence, number and/or makeup of customer's family members, or the like, purchase history of one or more such customers, one or more areas of the business enterprise identified as being frequently shopped by one or more customers, e.g., grocery, pharmacy, fuel, hardware, sporting goods, etc., virtual coupon type preference(s) identified by one or more customers, e.g., virtual coupons specifically for items in one or more identified business enterprise areas, virtual coupons for multiples of the same item, virtual coupons for seasonal items, or the like.

Some retail enterprises may include a single brick and mortar outlet, and other larger enterprises may include two or more physically remote brick and mortar outlets. In the latter case, the retail enterprise may include, for example, a main physical location with two or more remote physical locations, and for purposes of this document the two or remote physical locations in such an arrangement are referred to as “hub” locations. In this disclosure, the system 100 will be illustrated and described in the context of such a larger retail enterprise having a main physical location and two or more physical hub locations. In this regard, the system 100 shown in FIG. 1 illustratively includes the main server 102, which will typically be located at a main business location of the retail enterprise, coupled via the network 108 to two or more local hub servers 104, 106, each of which will typically be located at a different one of the two or more hub locations.

Each hub location may include any number of point-of-sale systems coupled to a corresponding local hub server, and in the embodiment illustrated in FIG. 1, for example, the local hub server 104 is communicatively coupled to “K” such point-of-sale systems 110₁-110_{K}, 110₁-110_{J} where K may be any positive integer, and the local hub server 106 is communicatively coupled to “J” such point-of-sale systems 110₁-110_{J}, where J may be any positive integer and where J may or may not be equal to K. Communicative coupling between the local hub server 104 and the one or more point-of-sale systems 110₁-110_{K}, and between the local hub server 106 and the one or more point-of-sale systems 110₁-110_{J}, may be accomplished using any known hardwire and/or wireless communication coupling, and communications over such hardwire and/or wireless coupling may be accomplished using any known communication protocol.

In some alternative embodiments of such a large retail enterprise, one or more of the local hub servers 104, 106 may be omitted, and the main server 102 may be coupled direction, via the network 108, to the one or more point-of-sale systems 110₁-110_{K}, 110₁-110_{J}, or the main server may be omitted and at least one of the local hub servers 104, 106 may be configured to act as a so-called master server with the remaining local hub servers 104, 106 configured to act as so-called slave servers. In other alternative embodiments in which the retail enterprise includes only a single brick and mortar outlet, the local hub server 104, 106 may be or include the main server 102 or vice versa. For purposes of the following description, any process disclosed as being controlled by the main server 102 may, in some embodiments, instead be controlled, in whole or in part, by one or more local hub servers 104, 106 and vice versa, and/or may be controlled, in whole or in part, by one of point-of-sale systems 110₁-110_{K}, 110₁-110_{J} and vice versa.

The local hub server 104 may be embodied as any type of server (e.g., a web server) or similar computing device capable of performing the functions described herein. In the illustrative embodiment of FIG. 1, the local hub server 104 includes a processor 120, an I/O subsystem 124, a memory 126, a data storage 128, a communication circuitry 130, and one or more peripheral devices 132. In some embodiments, several of the foregoing components may be incorporated on a motherboard or main board of the local hub server 104, while other components may be communicatively coupled to the motherboard via, for example, a peripheral port. Furthermore, it should be appreciated that the local hub server 104 may include other components, sub-components, and devices commonly found in a sever and/or computing device, which are not illustrated in FIG. 1 for clarity of the description.

The processor 120 of the local hub server 104 may be embodied as any type of processor capable of executing software/firmware, such as a microprocessor, digital signal processor, microcontroller, or the like. The processor 120 is illustratively embodied as a single core processor having a processor core 122. However, in other embodiments, the processor 120 may be embodied as a multi-core processor having multiple processor cores 122. Additionally, the local hub server 104 may include additional processors 120 having one or more processor cores 122.

The I/O subsystem 124 of the local hub server 104 may be embodied as circuitry and/or components to facilitate input/output operations with the processor 120 and/or other components of the local hub server 104. In some embodiments, the I/O subsystem 124 may be embodied as a memory controller hub, an input/output controller hub, and a firmware device. In such embodiments, the firmware device of the I/O subsystem 124 may be embodied as a memory device for storing Basic Input/Output System (BIOS) data and/or instructions and/or other information (e.g., a BIOS driver used during booting of the local hub server 104). However, in other embodiments, I/O subsystems having other configurations may be used. For example, in some embodiments, the I/O subsystem 124 may be embodied as a platform controller hub. In such embodiments, the memory controller hub may be incorporated in or otherwise associated with the processor 120, and the processor 120 may communicate directly with the memory 126 (as shown by the dashed line in FIG. 1). Additionally, in other embodiments, the I/O subsystem 124 may form a portion of a system-on-a-chip and be incorporated, along with the processor 120 and other components of the user computing device 104, on a single integrated circuit chip.

The processor 120 is communicatively coupled to the I/O subsystem 124 via a number of signal paths. These signal paths (and other signal paths illustrated in FIG. 1) may be embodied as any type of signal paths capable of facilitating communication between the components of the local hub server 104. For example, the signal paths may be embodied as any number of point-to-point links, wires, cables, light guides, printed circuit board traces, vias, bus, intervening devices, and/or the like.

The memory 126 of the user local hub server 104 may be embodied as or otherwise include one or more memory devices or data storage locations including, for example, dynamic random access memory devices (DRAM), synchronous dynamic random access memory devices (SDRAM), double-data rate synchronous dynamic random access memory device (DDR SDRAM), mask read-only memory (ROM) devices, erasable programmable ROM (EPROM), electrically erasable programmable ROM (EEPROM) devices, flash memory devices, and/or other volatile and/or non-volatile memory devices. The memory 126 is communicatively coupled to the I/O subsystem 124 via a number of signal paths. Although only a single memory device 126 is illustrated in FIG. 1, the user computing device 104 may include additional memory devices in other embodiments. Various data and software may be stored in the memory 126. For example, one or more operating systems, applications, programs, libraries, and drivers that make up the software stack executed by the processor 120 may reside in memory 126 during execution. The data storage 128 may be embodied as any type of device or devices configured for the short-term or long-term storage of data such as, for example, memory devices and circuits, memory cards, hard disk drives, solid-state drives, or other data storage devices.

The communication circuitry 130 of the local hub server 104 may include any number of devices and circuitry for enabling communications between the local hub sever 104 and the main server 102 and between the local hub server 104 and the one or more point-of-sale systems 110₁-110_{K}. In the illustrated embodiment, for example, communication between the local hub server 104 and the main server 102 takes place wirelessly via the network 108, wherein the network 108 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the local hub server 104 and the main server 102 may be, in whole or in part, a wired connection. Generally, the communication circuitry 130 may be configured to use any one or more, or combination, of secure and/or unsecure communication protocols to communicate with the main server 102 such as, for example, a wired network communication protocol (e.g., TCP/IP), a wireless network communication protocol (e.g., Wi-Fi®, WiMAX), a cellular communication protocol (e.g., Wideband Code Division Multiple Access (W-CDMA)), and/or other communication protocols. As such, the network 108 may include any number of additional devices, such as additional computers, routers, and switches, to facilitate communications between the local hub server 104 and the main server 102. As discussed hereinabove, communication between the local hub server 104 and the one or more point-of-sale systems 110₁-110ₖ may take place via one or more conventional wired or wireless communication interfaces.

In some embodiments, the local hub server 104 may also include one or more peripheral devices 132. Such peripheral devices 132 may include any number of additional input/output devices, interface devices, and/or other peripheral devices. For example, the peripheral devices 132 may include a display, a keyboard, a mouse, audio processing circuitry (including, e.g., conventional amplification circuitry and one or more speakers), and/or other input/output devices, interface devices, and/or peripheral devices.

The local hub server 106 may be substantially similar to the local hub server 104 and include similar components, which have been identified in FIG. 1 with common reference numbers. As such, the description provided above of the components of the local hub server 104 may be equally applicable to those similar components of the local hub server 106 and are not repeated herein so as not to obscure the present disclosure. Of course, it should be appreciated that in some embodiments the local hub server 104, 106 may be dissimilar to each other.

An embodiment of the main server 102 is also illustrated in FIG. 1, and generally includes the same components as the local hub server 104. For example, a processor 140, having a processor core 142, is coupled to an I/O subsystem 144, and the I/O subsystem 144 is coupled to a memory 146, a data storage unit 148, communication circuitry 150 and one or more peripheral devices 152. In some embodiments of the main server 104, the processor 140 may be coupled directly to the memory 146 as illustrated by the dashed-line connection in FIG. 1. The components 140, 144, 146, 148, 150 and 152 are identical in structure and operation to those described with respect to the local hub server 104 except for information stored in the data storage unit 148 and/or memory 146, which information may include data and/or one or more executable software algorithms. The communication circuitry 130 of each of the local hub servers 104, 106 facilitates communication with the communication circuitry 150 of the main server 102 so that information can be shared between the main server 102 and each of the one or more local hub servers 104, 106 via the network 108. Although only one such main server 102 is shown in FIG. 1, it should be appreciated that, in other embodiments, the system 100 may include any number of main servers. In any case, the main server 102 may be embodied as any type of server (e.g., a web server) or similar computing device capable of performing the functions described herein.

As briefly described above, the main server 102 may be communicatively coupled at any time via the network 114 to any of a number, M, of user computing devices 112₁-112_{M}, where M may be any positive integer, and the one or more user computing devices 112₁-112_{M} of the system 100 may be embodied as any type of computing device capable of performing the functions described herein. For example, each of the user computing devices 112₁-112_{M} may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a network appliance, a web appliance, a distributed computing system, a multiprocessor system, a processor-based system, a consumer electronic device, a digital television device, a set top box, and/or any other computing device configured to store and access data, and to execute electronic game software and related applications.

The communication circuitry 150 of the main server 102 may include any number of devices and circuitry for enabling communications between the main sever 102 and the one or more user computing devices 112₁-112_{M}. In the illustrated embodiment, for example, communication between the main server 102 and the one or more user computing devices 112₁-112_{M} takes place wirelessly via the network 114, wherein the network 114 may represent, for example, a private or non-private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the main server 102 and the one or more user computing devices 112₁-112_{M} may be, in whole or in part, a wired connection. Generally, the communication circuitry 150 may be configured to use any one or more, or combination, of secure and/or unsecure communication protocols to communicate with communication circuitry in the one or more user computing devices 112₁-112_{M} such as, for example, a wired network communication protocol (e.g., TCP/IP), a wireless network communication protocol (e.g., Wi-Fi®, WiMAX), a cellular communication protocol (e.g., Wideband Code Division Multiple Access (W-CDMA)), and/or other communication protocols. As such, the network 114 may include any number of additional devices, such as additional computers, routers, and switches, to facilitate communications between the main server 102 and the one or more user computing devices 112₁-112_{M}. In some embodiments, the network 114 and the network 108 may be or include a single network or a single collection of networks, such that the main server 102 communicates with the one or more local hub servers 104, 106 and with the one or more user computing devices 112₁-112_{M} via the same network or collection of networks. In other embodiments, the network 114 is wholly separate from the network 108, such that no part of the network 108 is shared with any part of the network 114 and such that the main server 102 communicates with the one or more local hub servers 104, 106 strictly via the network 108 and with the one or more user computing devices 112₁-112_{M} strictly via the network 114.

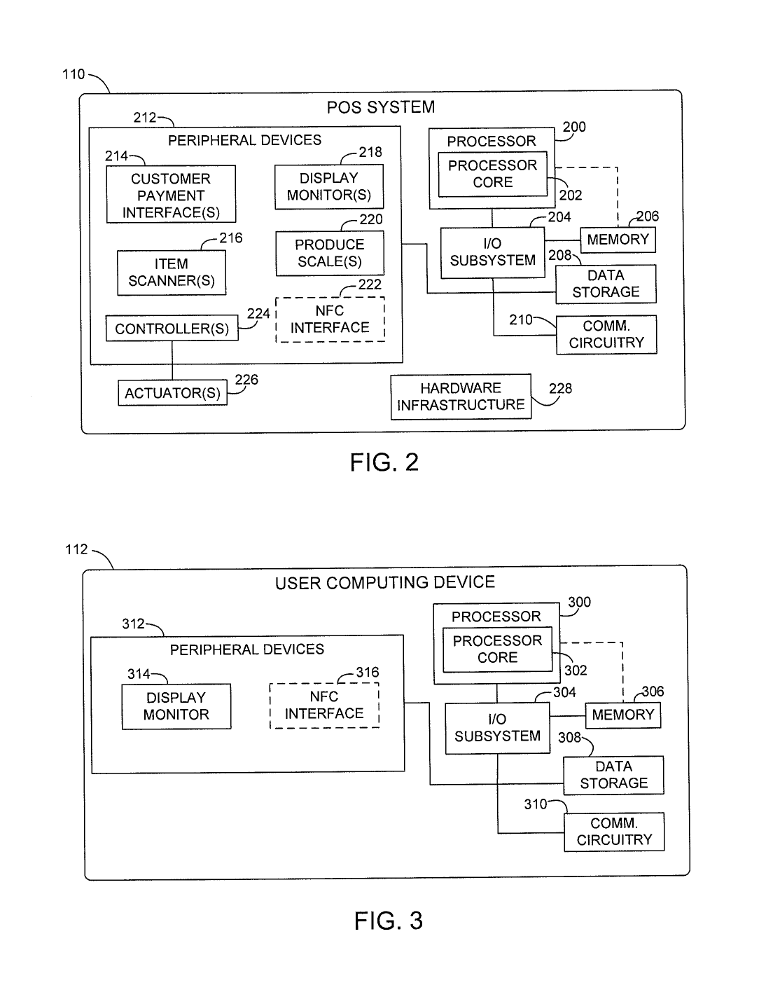

Referring now to FIG. 2, an embodiment 110 of one of the one or more point-of-sale systems 110₁-110_{K}, 110₁-110_{J}, is shown which includes components similar to the main server 102 and also to the one or more local hub servers 104, 106, such as a processor 200, an I/O subsystem 204, a memory 206, a data storage device 208, communication circuitry 210 and a number of peripheral devices 212. Additionally, the illustrated point-of-sale system 110 includes one or more actuators 226 and hardware infrastructure 228, examples of which will be described in detail hereinafter. It will be appreciated that the point-of-sale system 110 may include other components, sub-components, and devices commonly found in a computer and/or computing device. The processor 200 is communicatively coupled to the various components of the point-of-sale system 110 via a number of signal paths. These signal paths may be embodied as any type of signal paths capable of facilitating communication between the components of the point-of-sale system 110. For example, the signal paths may be embodied as any number of wires, cables, light guides, printed circuit board traces, via, bus, link, interconnect, intervening devices, and/or the like.

The processor 200 of the point-of-sale system 110 may be embodied as any type of processor capable of executing software/firmware, such as a microprocessor, digital signal processor, microcontroller, or the like. The processor 200 is illustratively embodied as a single core processor having a processor core 202. However, similar to the processors 120 and 140 described above, the processor 200 may be embodied as a multi-core processor having multiple processor cores 202 in other embodiments. Additionally, the point-of-sale system 110 may include additional processors 200 having one or more processor cores 202.

The memory 206 of the point-of-sale system 110 may be embodied as or otherwise include one or more conventional memory devices or data storage locations. The data storage device(s) 208 of the point-of-sale system 110 may be embodied as any type of device or devices configured for the short-term or long-term storage of data and in some embodiments, the data storage device(s) 208 may be used to store information corresponding to one or more sales transaction. The communication circuitry 210 is configured to facilitate communication with a corresponding one of the local hub servers 104, 106 and the point-of-sale system 110 may use any suitable communication protocol to communicate with the corresponding local hub server 104, 106.

The peripheral devices 212 of the point-of-sale system 110 may include any number of peripheral or interface devices. Examples of some of the peripheral devices 212 illustrated in FIG. 2 include, but should not be limited to, one or more conventional customer payment interfaces 214, one or more conventional item price scanners 216, one or more conventional display monitors 218, one or more conventional produce scales 220 and one or more conventional controllers 224 for controlling one or more conventional actuators 226 associated with the operation of the point-of-sale system 110. The one or more customer payment interfaces 214 are provided, e.g., to facilitate receipt of credit card and/or other form of payment from customers, and each such interface 214 may illustratively include one or more of a display, a touch screen, a keyboard, a mouse, external speakers, and/or other peripheral devices. One or more of the one or more customer payment interfaces 214 may further include a produce scale 220, and one or more produce scales 220 may alternatively be coupled to the point-of-sale system 110 separately from the one or more customer payment interfaces 214. The one or more item scanner(s) 216 is/are configured to scan price code labels or other such indicators for items being purchased by customers. The one or more display monitor(s) 218 provide item and/or pricing information to customers and/or enterprise employees, and may further provide additional information regarding cost and/or discounts for one or more items being purchased as well as information regarding discounts realized by customers through the use of print media and/or virtual coupons. The peripheral devices 212 of the point-of-sale system 110 may further optionally include a near-field communication device 222, as illustrated in dashed-line configuration in FIG. 2, which may be included in embodiments in which one or more of the user computing devices 112₁-112_{M} also has such a near-field communication device such that customer information, e.g., customer identification information in the form of one or more identification codes, user names, passwords, or the like, can be transferred from such one or more of the user computing devices 112₁-112_{M} to the point-of-sale system 110 by tapping the two near-field communication devices together or by passing the near-field communication device of a so-equipped user computing device 112₁-112_{M} sufficiently close to the near-field communication device 222 to effectuate such communication.

The point-of-sale system 110 further includes hardware infrastructure 228 which forms the structural backbone of the point-of-sale system 110. Examples of structural components that may be included in the hardware infrastructure 228 include, but should not be limited to, one or more purchased item transport units, e.g., one or more purchased item conveyance units or systems, one or more conventional purchased item bagging areas, e.g., one or more conventional item bagging carousals, one or more purchased item support units, and the like. The one or more actuators 226 may be or include any actuator is controllable by at least one of the one or more conventional controllers 224, and which may facilitate operation and/or control of the hardware infrastructure of the point-of-sale system 110. Examples of such one or more actuators may include, but should not be limited to, one or more linear and/or rotational drive motors, one or more electronically controlled switches, and the like.

Referring now to FIG. 3, an embodiment of one of the user computing devices 112 is shown which includes components similar to the main server 102 and also to the one or more local hub servers 104, 106, such as a processor 300, an I/O subsystem 304, a memory 306, a data storage device 308, communication circuitry 310 and a number of peripheral devices 312. It will be appreciated that the user computing device 112 may include other components, sub-components, and devices commonly found in a computer and/or computing device. The processor 300 is communicatively coupled to the various components of the user computing device 112 via a number of signal paths. These signal paths may be embodied as any type of signal paths capable of facilitating communication between the components of the user computing device 112. For example, the signal paths may be embodied as any number of wires, cables, light guides, printed circuit board traces, via, bus, link, interconnect, intervening devices, and/or the like.

The processor 300 of the user computing device 112 may be embodied as any type of processor capable of executing software/firmware, such as a microprocessor, digital signal processor, microcontroller, or the like. The processor 300 is illustratively embodied as a single core processor having a processor core 302. However, similar to the processors 120, 140 and 200 described above, the processor 300 may be embodied as a multi-core processor having multiple processor cores 302 in other embodiments. Additionally, the user computing device 112 may include additional processors 300 having one or more processor cores 302.

The memory 306 of the user computing device 112 may be embodied as or otherwise include one or more conventional memory devices or data storage locations. The data storage device(s) 308 of the user computing device 112 may be embodied as any type of device or devices configured for the short-term or long-term storage of data and in some embodiments. The communication circuitry 310 is configured to facilitate communication with the main server 102 via the network 114 as described above, and the user computing device 112 may use any suitable communication protocol to communicate with the main server 102.

The peripheral devices 312 of the user computing device 112 may include any number of peripheral or interface devices. For example, the peripheral device 312 illustrated in FIG. 3 includes a conventional display monitor or screen 314. In some embodiments, as illustrated by dashed-line representation in FIG. 3, the peripheral devices 312 may include a near-field communication device 316 which may be used to exchange information with any similarly equipped ones of the one or more of the point-of-sale systems 110₁-110_{K}, 110₁-110_{J} as discussed above. For example, the near-field communication device 316 may be used to transfer customer information, e.g., customer identification information in the form of one or more identification codes, user names, passwords, or the like, from the user computing device 112 to such similarly equipped ones of the one or more of the point-of-sale systems 110₁-110_{K}, 110₁-110_{J} as further described above.

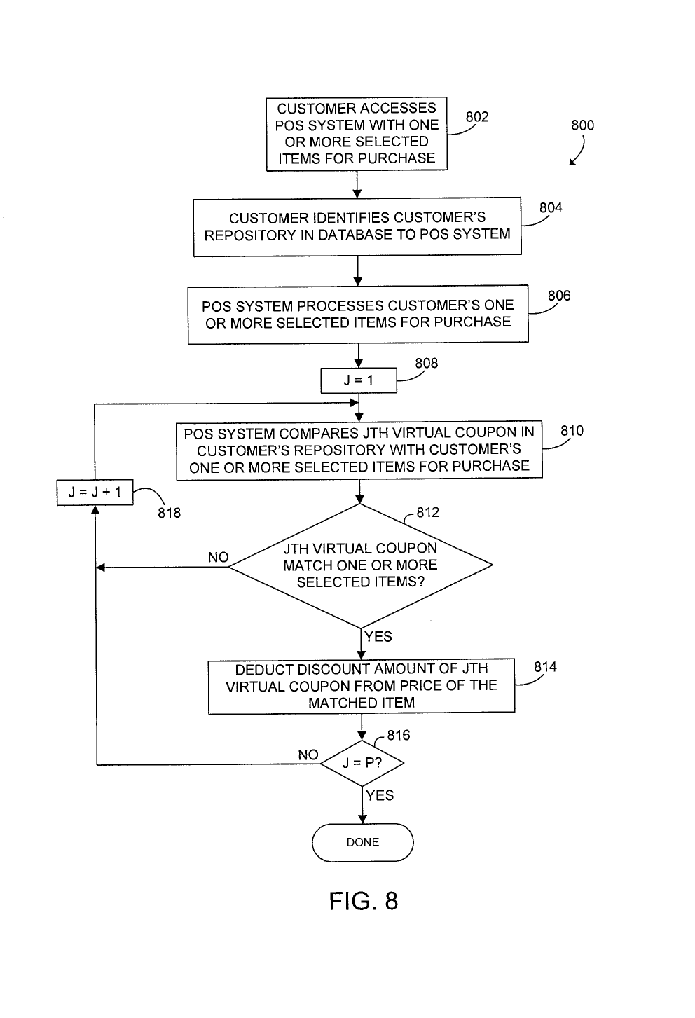

One or more customers of the business enterprise has an associated virtual customer coupon repository within a database of the main server 102, which repository which has one or more virtual coupons stored therein for use, i.e., redemption, only by that customer at any of the one or more point-of-sale systems 110₁-110_{K}, 110₁-110_{J}. Such a dedicated virtual customer coupon repository may, in some embodiments, be available to customers who join a shopping club or similar service offered by the business enterprise in which customers provide the business enterprise with certain personal identification information and which the service typically then, in turn, provides discount offers for one or more items purchasable from the business enterprise, e.g., in the form of one or more corresponding virtual coupons. In such embodiments, customers may illustratively be issued a membership card or other such token which includes one or more identification codes unique to each such card or token (and therefore unique to each customer). Such one or more unique identification codes can be entered into any of the one or more point-of-sale systems 110₁-110_{K}, 110₁-110_{J}, e.g., by scanning a barcode or magnetic strip or other such identification code-carrying structure attached to or integral with the membership card or other such token and/or by manually or otherwise entering the one or more unique identification codes into a point-of-sale system 110₁-110_{K}, 110₁-110_{J}. When any such one or more unique identification codes is entered into a point-of-sale system 110₁-110_{K}, 110₁-110_{J}, the processor 200 of the point-of-sale system 110₁-110_{K}, 110₁-110_{J} identifies the customer and associates that customer with the current purchase transaction being carried out at the point-of-sale system 110₁-110_{K}, 110₁-110_{J}. The point-of-sale system 110₁-110_{K}, 110₁-110_{J}, which is communicatively coupled to the main server 102 via a local hub server 104, 106, can then access virtual coupons resident within that customer's virtual customer coupon repository in the main server 102, and can automatically redeem each virtual coupon in the customer's virtual customer coupon repository that matches an item being purchased by the customer in the current purchase transaction, as will be described further below with respect to FIG. 8. MPERKS®, a virtual customer coupon collection and redemption program offered to customers by Meijer, Inc. of Grand Rapids, Mich., is an example of one such shopping club or similar service, although it will be appreciated that any virtual customer coupon service which makes available to customers virtual customer coupon repositories in which virtual coupons can be stored and automatically redeemed by customers during item purchase transactions at point-of-sale systems or terminals may be alternatively be used.

In any case, the one or more virtual coupons stored in the customer's virtual customer coupon repository within a database of the main server 102 may be accessed and managed by the customer via one of the user computing devices 112₁-112_{M}. In this regard, the memory 306 and/or the data storage 308 of the user computing device 112 illustratively has one or more sets of instructions stored therein that is/are executable by the processor 300 to display on the display monitor 314 the contents of the customer's virtual customer coupon repository and to allow the customer to receive, manipulate and manage virtual coupons within that customer's virtual customer coupon repository.

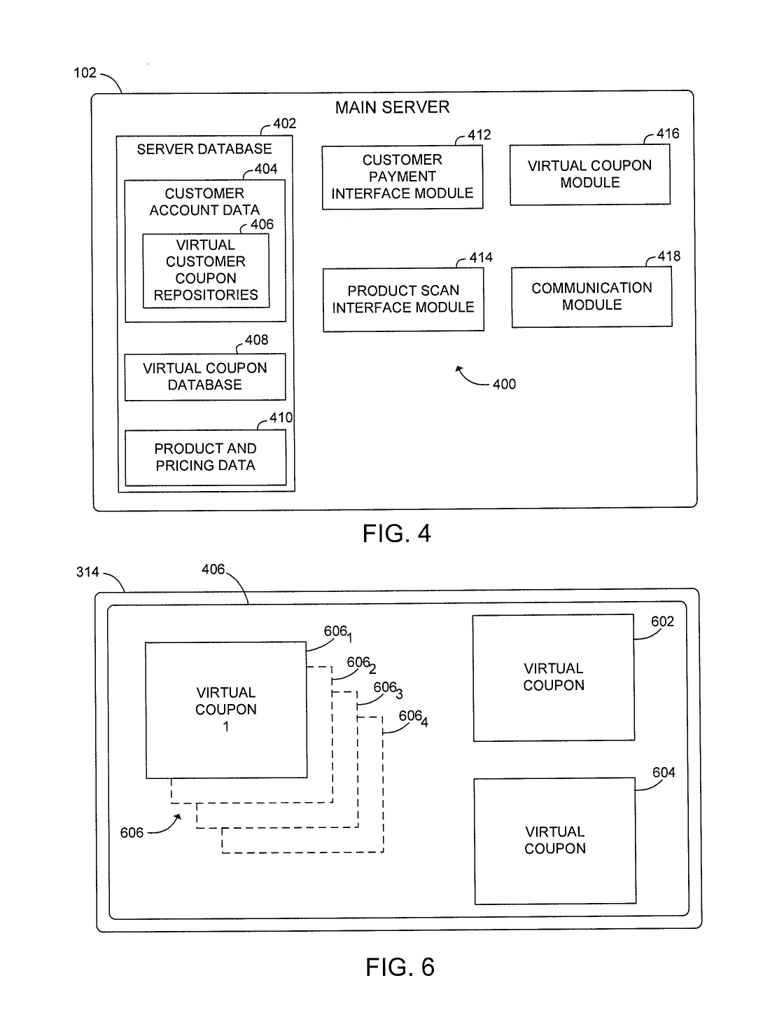

Referring now to FIG. 4, a simplified block diagram is shown of an embodiment of an environment 400 of the main server 102 illustrated in FIG. 1. In the illustrated embodiment, the environment 400 includes a server database 402 which includes customer account data 404, a virtual coupon database 408 and product and pricing data 410. The customer account data 404 has stored therein all account-related information for customers which have a customer account with the business enterprise, i.e., which have joined, and are members of, a virtual customer coupon service hosted by the business enterprise. Examples of the account-related information for each customer in the customer account data portion 404 of the server database 402 may include, but should not be limited to, customer name, customer mailing address, one or more customer e-mail addresses, one or more customer telephone or cellular telephone numbers, customer age, customer gender, customer marital status, number, gender and/or ages of family members, business units or areas of the business enterprise in which the customer regularly purchases items (e.g., grocery, pharmacy, hardware, sporting goods, fuel, etc.), virtual coupon preferences, e.g., preference(s) for discounts in one or more areas of the business enterprise, such as one or more of groceries, medical prescriptions, gasoline (or diesel fuel), hardware, sporting goods, seasonal items, etc., and the like. Additionally, the customer account data 402 includes unique customer identification information associated with each such customer account, examples of which may be or include any one or more of a personal identification number (PIN), alphanumeric code, password, user name or code or other identification data that is unique to each customer. The unique customer identification information (Customer ID) assigned to any such customer may be provided on a physical medium such as a card or other token in the form of, for example, a bar code that may be scanned at a point-of-sale system 110₁-110_{K}, 110₁-110_{J}, a magnetic strip or radio-frequency identification (RFID) tag that may be read at a point-of-sale system 110₁-110_{K}, 110₁-110_{J}, or the like. Alternatively or additionally, the Customer ID may be stored in or on an electronic device, such as a smart phone, personal data assistant, tablet computer or the like, and which may be provided to a point-of-sale system 110₁-110_{K}, 110₁-110_{J} via a suitable wireless communication mechanism, e.g., near-field communication device, radio-frequency transmitter or transceiver, or other such mechanism. Alternatively or additionally still, the Customer ID may be manually entered into a point-of-sale system 110₁-110_{K}, 110₁-110_{J} by the customer and/or by an employee of the business enterprise, e.g., a cashier, using a keyboard, keypad, touch screen, or the like, and with or without the assistance of a conventional customer lookup application.

In any case, the customer account data 404 further includes a plurality of virtual customer coupon repositories 406, i.e., a portion of the database 402 in which virtual customer coupons are stored. A separate virtual customer coupon repository is provided for each customer having a customer account with the business enterprise, i.e., each customer that has joined the virtual customer coupon service hosted by the business enterprise. Each such virtual customer coupon repository may be provided in a physically separate part or portion of the server database 402, or may alternatively be provided in a common virtual customer coupon repository in which each separate virtual customer coupon repository is maintained separately from the others such that only the business enterprise and the customer has access to that customer's virtual customer coupon repository 406. In either form, one or more of the virtual customer coupon repositories 406 may alternatively be stored, in whole or in part, in one or more other databases and/or memory, e.g., a database 128 and/or memory 126 within one or more of the local hub servers 104, 106, a database 208 and/or memory 206 within one or more of the point-of-sale systems 110₁-110_{K}, 110₁-110_{J}, a database 308 and/or memory 306 within one of the user computing devices 112₁-112_{M}, or the like. In any case, each such virtual customer coupon repository is linked with a corresponding Customer ID such that access to any particular virtual customer coupon repository may be gained by entering a corresponding Customer ID into the main server 102. The main server 102 is configured in a conventional manner to provide such access to virtual customer coupon repositories based on Customer ID.

The virtual coupon database 408 holds virtual coupons which are provided by the main server 102 to customers, i.e., which may be selectively transferred by the main server 102 (e.g., by the processor 140) to one or more of the virtual customer coupon repositories 406. In some embodiments, customers may also add virtual coupons to their virtual customer coupon repositories 406 from other sources, although redemption by the main server 102 of any such virtual coupons from other sources will generally be subject to rules established by the business enterprise. In any case, the main server 102 may be configured in a conventional manner to selectively transfer individual virtual coupons to one or more of the virtual customer coupon repositories, and/or to selectively transfer sequences of virtual coupons, e.g., virtual bounce back coupons, to one or more of the virtual customer coupon repositories as will be described in detail hereinafter. Generally, the population of virtual coupons stored in the virtual coupon database 408 will be dynamic, and the makeup of this population at any time will typically depend on one or more factors, examples of which may include, but should not be limited to, discounts provided by manufacturers/suppliers of items offered for sale by the business enterprise, season of the year, promotional events, item inventory, targeted sales efforts, and the like.

The product and pricing data 410 portion of the server database 402 includes product identification and pricing information for items offered for sale by the business enterprise. Illustratively, the product pricing information is linked to the product identification information via scan codes such that when items are scanned for purchase, the scan code of each item will identify a particular item at a particular price in the product and pricing database 410.

The environment 400 of the main server 1012 further includes a customer payment interface module 412, a product scan interface module 414, a virtual coupon module 416 and a communication module 418. The customer payment interface module 412 is configured, in a conventional manner, to process electronic forms of customer payment, e.g., credit card, debit card, etc., used at the point-of-sale systems 110₁-110_{K}, 110₁-110_{J}. The product scan interface module 414 is configured, in a conventional manner, to link item scanning activity at the point-of-sale systems 110₁-110_{K}, 110₁-110_{J} to the product and pricing database 410 so that the point-of-sale systems 110₁-110_{K}, 110₁-110_{J} have accesses to current item identity and pricing information for items being purchased. The virtual coupon module 416 is configured to selectively transfer individual virtual coupons to one or more of the virtual customer coupon repositories, and to selectively transfer sequences of virtual coupons, e.g., virtual bounce back coupons, to one or more of the virtual customer coupon repositories as will be described in detail below. The communication module 418 is configured, in a conventional manner, to manage all communications between the main server 102 and the local hub servers 104, 106, and between the main server 102 and the user computing devices 112₁-112_{M}.

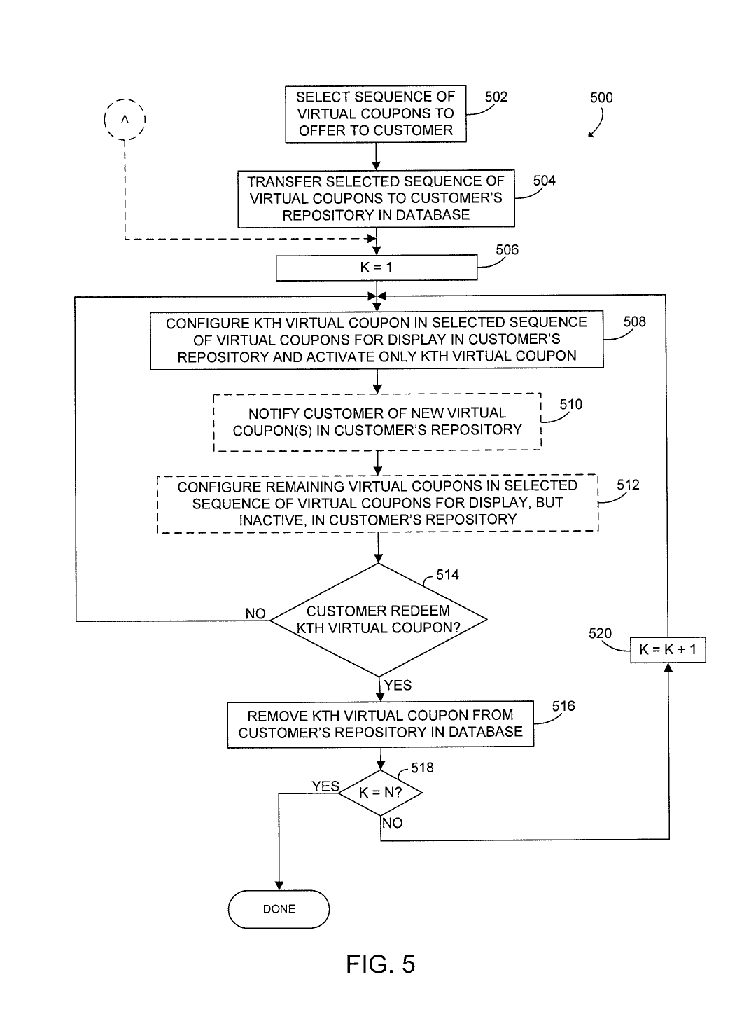

Referring now to FIG. 5, a simplified flow diagram is shown of an embodiment of a process 500 for selectively providing virtual bounce back coupons for customer use at a retail enterprise. In one embodiment, the process 500 is stored in the memory 146 and/or data storage 148 of the main server 102 in the form of one or more sets of instructions executable by the processor 140. In alternative embodiments, some or all of the one or more sets of instructions may be stored in a memory and/or data storage of a local hub server 104, 106 and executed by a processor 120 of the local hub server 104, 106, and/or may be stored in a memory and/or data storage of a point-of-sale system 110₁-110_{K}, 110₁-110_{J} and executed by a processor 200 of the point-of-sale system 110₁-110_{K}, 110₁-110_{J}. For purposes of this disclosure, the process 500 will be described as being executed by the processor 140 of the main server 102, although it will be understood that some or all of the process 500 may alternatively be executed by a processor 120 of a local hub server 104, 106 and/or by a processor 200 of a point-of-sale system 110₁-110_{K}, 110₁-110_{J}.

The process 500 illustrated in FIG. 5 provides a sequence of virtual coupons to a customer that is a member of a virtual customer coupon service hosted by a business enterprise, and such a customer therefore has an associated virtual customer coupon repository 406 in the server database 402. Hereafter in this document, the term “customer” will refer to a member of a virtual coupon service hosted by a business enterprise, and the term “customer's repository” will refer to a virtual customer coupon repository 406, or portion thereof, of the server database 402 assigned by the business entity to that customer. It will be understood that the customer will be linked to the customer's repository by a unique Customer ID, as this term is defined above, and that the processor 140 of the main server 102 uses this Customer ID to accesses the customer's repository at the direction of the customer via an associated one of the user computing devices 112₁-112_{M}, at the direction of an employee of the business entity and/or pursuant (e.g., automatically) to instructions executed by the processor 140 as part of a virtual coupon offer and/or as part of an item sale/purchase transaction undertaken by the customer. It will be appreciated that while the process 500 illustrated in FIG. 5 provides a single sequence of virtual coupons for use by a single customer, the process 500 may be repeated any number of times to provide the customer with multiple sequences of virtual coupons and/or may be used to provide one or more sequences of virtual coupons to multiple customers.

In any case, the process 500 begins at step 502 where the processor 140 selects a sequence of virtual coupons to offer to a customer. The sequence of virtual coupons selected by the processor 140 at step 502 may be selected from the total pool of virtual coupons in the virtual coupon database 408, or may alternatively be selected from one or more defined subsets of the total pool of virtual coupons in the virtual coupon database 408. The processor 140 may be programmed, i.e., may execute one or more sets of instructions, to select the sequence of virtual coupons at step 502 based on a single virtual coupon offer criterion or based on multiple virtual coupon offer criteria. Examples of the virtual coupon offer criterion or criteria may include, but should not be limited to, all customers, a random selection of such customers, one or more targeted subgroups of customers, one or more subgroups of customers sharing at least one common trait, e.g., age, gender, letter of first and/or last name, geographical location of residence, number and/or makeup of customer's family members, or the like, purchase history of one or more such customers, one or more areas of the business enterprise identified as being frequently shopped by one or more customers, e.g., grocery, pharmacy, fuel, hardware, sporting goods, etc., virtual coupon type preference(s) identified by one or more customers, e.g., virtual coupons specifically for items in one or more identified business enterprise areas, virtual coupons for multiples of the same item, virtual coupons for seasonal items, or the like.

Following step 502, the process 500 advances to step 504 where the processor 140 transfers the selected sequence of virtual coupons from the virtual coupon database 408 to the customer's repository 406 in the server database 402. In one embodiment, the processor 140 executes step 504 by transferring copies of the selected sequence of virtual coupons to the customer's repository 406. Alternatively, with one or more virtual coupons the processor 140 may execute step 504 by moving one or more virtual coupons from the virtual coupon database 408 to the customer's repository 406, e.g., in instances where the customer is the last customer to receive the virtual coupon before discontinuing the virtual coupon. Following step 504, the process 504 advances to step 506, where the processor 140 sets a counter, K, equal to an initial value, e.g., 1. Generally, the sequence of virtual coupons selected at step 502 and transferred to the customer's repository 406 at step 504 will include N virtual coupons, where N may be any positive integer greater than 1.

Following step 506, the process 500 advances to step 508 where the processor 140 configures the Kth virtual coupon for display in the customer's repository 406, and the processor 140 is also operable at step 508 to “activate” only the Kth virtual coupon, i.e., to configure the Kth virtual coupon to be redeemable by the customer at a point-of-sale system 110₁-110_{K}, 110₁-110_{J}. In one embodiment, the virtual coupons K+1 through N are not configured for display to the customer via the customer's repository 406, and are instead configured to be invisible to the customer when viewing the customer's repository 406. In this embodiment, the next, but not yet redeemed, virtual coupon in the selected sequence of virtual coupons is displayed to the customer when viewing the customer's repository 406, and is active, i.e., redeemable by the customer. The remaining virtual coupons in the sequence are, in this embodiment, maintained invisible to the customer, and in any case all are currently inactive, i.e., non-redeemable. The next, but not yet redeemed, virtual coupon in the selected sequence of virtual coupons is the only one of the selected sequence of virtual coupons that is currently active, i.e., redeemable. At the first execution of step 508, e.g., K=1, only the first virtual coupon in the selected sequence of virtual coupons is configured for display to the customer via the customer's repository 406, and the first virtual coupon in the selected sequence of virtual coupons is the only one of the selected sequence of virtual coupons that is currently active, i.e., redeemable.

Referring to FIG. 6, a simplified block diagram is shown of an example embodiment of the customer's repository 406 within the server database 402 of the main server 102, as viewed on the display monitor 314 of the customer's user computing device 112₁-112_{M}, at a point in time just after the first execution (K=1) of step 508. In the illustrated embodiment, the customer's repository 406 contains a pair of single virtual coupons 602 and 604, and a single sequence 606 of 4 virtual coupons 606₁-606₄. In the sequence 606 of virtual coupons, the first virtual coupon 606₁ is illustrated with a solid outline to indicated that the virtual coupon 606₁ is configured to be viewed by the customer when the customer's repository 406 is accessed by the customer via a user computing device 112₁-112_{M}, and that the virtual coupon 606₁ is currently active, i.e., redeemable. The remaining virtual coupons 606₂-606₄ are illustrated with dashed-line outlines to indicate that these virtual coupons 606₂-606₄ are not configured to be viewed by the customer, but are rather configured to be invisible, when the contents of the customer's repository 406 are accessed by the customer. In the example illustrated in FIG. 6, the virtual coupon 606₁ is the only currently active one of the sequence of virtual coupons 606 in that it is the only one of the sequence of virtual coupons 606 than can presently be redeemed. The remaining virtual coupons 606₂-606₄ are, in contrast, presently dormant, i.e., non-redeemable, although each will become redeemable at the time the virtual coupon before it in the sequence is redeemed. The virtual coupon 606₁ is termed the “parent” virtual coupon because it is the first virtual coupon in the sequence 606 of virtual coupons, and it is the first virtual coupon in the sequence 606 to be activated, i.e., redeemable. In the embodiment of the process 500 illustrated in FIG. 5, the first virtual coupon 606₁ is activated at the time that the processor 140 configures this first virtual coupon 606₁ for display in the customer's repository 406. In alternate embodiments, the processor 140 may activate the first virtual coupon 606₁ at different times and/or upon detection of one or more events. The remaining virtual coupons 606₂-606₄ are termed “bounce back” virtual coupons because when they are transferred by the processor 140 to the customer repository 406 they are not initially active, i.e., redeemable; rather, the processor 140 responds to the sequential redemption of each of the virtual coupons 606₁-606₃ to activate or “bounce back” the next one of the virtual coupons 606₂-606₄ in the sequence 606.

Referring again to FIG. 5, the process 500 advances, in one embodiment, from step 508 to step 510 where the processor 140 notifies the customer of the new virtual coupon(s) in the customer's repository 406. In some alternate embodiments, step 510 may omitted, and step 510 is outlined in FIG. 5 with a dashed-line to illustrate this feature. In embodiments which include step 510, the processor 140 is illustratively operable at step 510 when K=1 to notify the customer of the new virtual coupon(s) by notifying the customer of the existence of the newly added sequence, e.g., the sequence 606 illustrated in FIG. 6, of virtual coupons. Alternatively or additionally, the processor 140 may be operable at step 510 to notify the customer of the first active one of the newly added sequence of virtual coupons. The process 140 may be operable at step 510 when K>1 to notify the customer of the new virtual coupon(s) by notifying the customer of the newly activated bounce-back virtual coupon, i.e., the newly activated, next virtual coupon in the selected sequence of virtual coupons following redemption of the previous virtual coupon in the sequence. In any case, the processor 140 may notify the customer at step 510 by controlling the communication module 418 to transmit a the corresponding communication to the customer using any conventional notification mechanism(s)/method(s). Examples of such some such conventional notification mechanism(s)/method(s) include, but should not be limited to, e-mail, mobile messaging service, blogging or microblogging service, automatically generated telephone call, e.g., using a pre-programmed recording or machine-generated voice, textual, graphic, audio, visual or multimedia message posted on one or more pages of one or more social networks of which the customer is a member, and the like.

In some embodiments, as discussed above with respect to step 508, the virtual coupons K+1 through N are not configured for display to the customer via the customer's repository 406, and are instead configured to be invisible to the customer when viewing the customer's repository 406. In alternate embodiments, the process 500 may include step 512 in which the processor 140 configures all but the currently active one, i.e., the Kth, of the sequence of virtual coupons for display in the customer's repository while maintaining all such virtual coupons inactive, i.e., currently non-redeemable. In embodiments which include step 510, the process 500 advances to step 512 from step 510, and in embodiments which do not include step 510, the process 500 advances to step 512 from step 508.

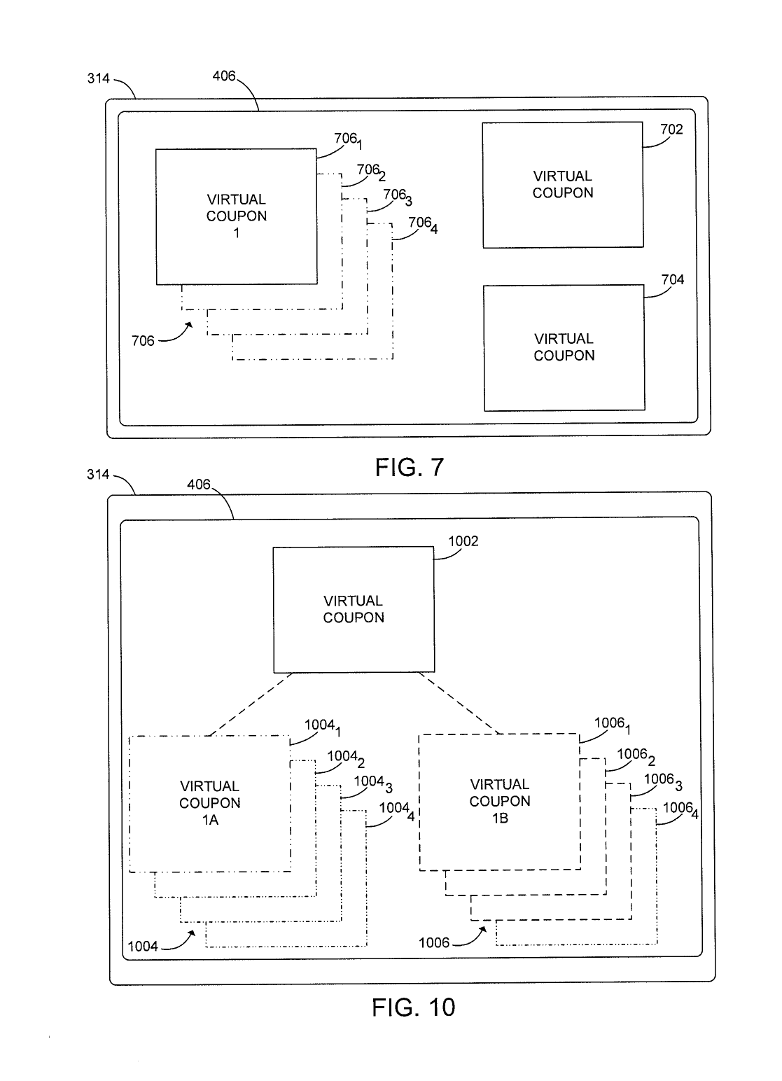

Referring to FIG. 7, a simplified block diagram is shown of an example embodiment of the customer's repository 406 within the server database 402 of the main server 102, as viewed on the display monitor 314 of the customer's user computing device 112₁-112_{M}, at a point in time just after the first execution (K=1) of step 508 in embodiments which include step 512. In the illustrated embodiment, the customer's repository 406 contains a pair of single virtual coupons 702 and 704, and a single sequence 706 of 4 virtual coupons 706₁-706₄. In the sequence 706 of virtual coupons, the first virtual coupon 706₁ is illustrated with a solid outline to indicated that the virtual coupon 706₁ is configured to be viewed by the customer when the customer's repository 406 is accessed by the customer via a user computing device 112₁-112_{M}, and that the virtual coupon 706₁ is currently active, i.e., redeemable. The remaining virtual coupons 706₂-706₄ are illustrated with dashed-dotted outlines to indicate that these virtual coupons 706₂-706₄ are configured to be viewed by the customer when the contents of the customer's repository 406 are accessed by the customer, but that these virtual coupons 706₂-706₄ are currently inactive, i.e., non-redeemable.

In embodiments in which currently inactive, i.e., dormant, ones of the selected sequence of virtual coupons are configured to be viewed by the customer when the contents of the customer's repository 406 are accessed by the customer, the processor 140 is illustratively operable at step 512 to configure such virtual coupons such that information about the products and the associated discounts can be viewed by the customer even though such virtual coupons are currently inactive. The processor 140 may be further operable at step 512 to configure such virtual coupons such that while information about the products and associated discounts are viewable it is readily apparent from the appearance of such virtual coupons that they are currently inactive. Examples of so configuring the viewable but currently inactive virtual coupons may include, but should not be limited to, configuring such virtual coupons to be at least partially transparent, configuring such virtual coupons to be a different color or colors than the currently active one of the sequence of virtual coupons, configuring such virtual coupons to have no color other than black, white and shades of gray, and the like. In any case, in the example illustrated in FIG. 7, the virtual coupon 706₁ is the only currently active one of the sequence of virtual coupons 706 in that it is the only one of the sequence of virtual coupons 706 than can presently be redeemed. The remaining virtual coupons 706₂-706₄, while visible and viewable by the customer, are presently inactive or dormant, i.e., non-redeemable, although each will become redeemable at the time the virtual coupon before it in the sequence is redeemed.

Referring again to FIG. 5, the process 500 advances from step 512, in embodiments which include step 512, from step 510 in embodiments which include step 510 but not step 512, or from step 508 in embodiments which do not include either of steps 510 or 512, to step 514 where the processor 140 determines whether the customer has redeemed the Kth virtual coupon, i.e., the active one of the selected sequence of virtual coupons. If not, the process 500 loops back to step 508, and if so the process 500 advances to step 516.

As described briefly hereinabove, the processor 140 of the main server illustratively executes a process which automatically redeems a virtual coupon resident in a customer's repository when a customer purchases an item that matches the virtual coupon. Referring now to FIG. 8, a simplified flow diagram is shown of at least one embodiment of such a process 800 for automatically redeeming of one or more such virtual coupons as customers purchase one or more corresponding items at a point-of-sale system 110₁-110_{K}, 110₁-110_{J}. In one embodiment, some parts of the illustrated process 800 are carried out by a customer and other parts are stored in the memory 206 and/or data storage 208 of a point-of-sale system 110₁-110_{K} in the form of one or more sets of instructions executable by the processor 200, and still other parts are stored in the memory 146 and/or data storage 148 of the main server 102 in the form of one or more sets of instructions executable by the processor 140. In alternative embodiments, some or all of the one or more sets of instructions may be stored in a memory and/or data storage of a local hub server 104, 106 and executed by a processor 120 of the local hub server 104, 106. For purposes of this disclosure, some steps of the process 800 will be described as being executed by the processor 140 of the main server 102 and others will be described as being executed by the processor 200 of a point-of-sale system 110₁-110_{K}, 110₁-110_{J}, although it will be understood that some or all of the process 800 may alternatively be executed by a processor 120 of a local hub server 104, 106.

The process 800 begins at step 802 where the customer accesses a point-of-sale system 110₁-110_{K}, 110₁-110_{J} with one or more selected items for purchase, e.g., resulting from a shopping expedition at an retail outlet of the business enterprise. Thereafter at step 804, the customer identifies that customer's repository in the server database 402 to the processor 200 of the point-of-sale system 110₁-110_{K}, 110₁-110_{J}. In one embodiment, as described in detail above, step 804 may be carried out by providing the customer's Customer ID to the processor 200 of the point-of-sale system 110₁-110_{K}, 110₁-110_{J}, and the processor 200 of the point-of-sale system 110₁-110_{K}, 110₁-110_{J} is operable to transfer the obtained Customer ID to the main server 102. Thereafter at step 806, the processor 200 of the point-of-sale system 110₁-110_{K}, 110₁-110_{J} processes, e.g., price scans, each of the one or more items selected for purchase by the customer. Thereafter at step 808, the processor 200 sets a counter, J, to an initial value, e.g., 1. Thereafter at step 810, the processor 200 of the point-of-sale system 110₁-110_{K}, 110₁-110_{J} compares the Jth virtual coupon in the customer's repository with each of the items selected for purchase by the customer and scanned by the point-of-sale system 110₁-110_{K}, 110₁-110_{J}. Thereafter at step 812, the processor 200 determines whether the Jth virtual coupon in the customer's repository matches one or more of the items selected for purchase by the customer. If not, the processor 200 advances to step 818 to increment the value of the counter J, e.g., by 1, before looping back to step 810. If, at step 812, the processor 200 determines that the Jth virtual coupon in the customer's repository matches one or more of the items selected for purchase by the customer, the process 800 advances to step 814 where the processor 200 deducts the discount amount of the Jth virtual coupon from the price of the matched item(s). Thereafter at step 816, the processor 200 determines whether the Jth virtual coupon in the customer's repository is the last (P) virtual coupon in the customer's repository 406, where P may be any positive integer. If not, the process 800 loops back to step 818, and otherwise the process 800 is completed.

Referring again to FIG. 5, the process 500 advances from the “YES” branch of step 514 to step 516 where the processor 140 removes the now-redeemed Kth virtual coupon from the customer's repository 406 in the server database 402. Thereafter at step 518, the processor 140 determines whether the Kth virtual coupon just redeemed and removed from the customer's repository 406 is the last (N) of the selected sequence of virtual coupons transferred to the customer's repository at step 504. If not, the process 500 advances to step 520 where the processor 140 increments, e.g., by 1, the value of the counter K, and then loops back to step 508 where the processor 140 activates and configures the previously inactive, and in some embodiments invisible, next virtual coupon in the selected sequence of coupons for display in the customer's repository 406. If, at step 518, the processor 140 determines that the Kth virtual coupon just redeemed and removed from the customer's repository 406 is the last (N) of the selected sequence of virtual coupons that were transferred to the customer's repository at step 504, the process 500 is completed and advances to DONE.

The process 500 just described selectively provides one or more single sets of virtual bounce back coupons for customer use at a retail enterprise. Alternatively or additionally, the process 500 may be modified to provide multiple sets of virtual bounce back coupons each linked to a single parent virtual coupon, with the customer then being required to choose one of the multiple sets of virtual bounce back coupons to sequentially redeem following redemption of the parent virtual coupon. Referring to FIG. 5, a sub-process A is shown in dashed-line form to indicate that this sub-process may or may not be added to the process 500 just described. In one embodiment, the sub-process A may be added as illustrated to include providing one or more such multiple sets of virtual bounce back coupons in addition to providing one or more single sets of virtual bounce back coupons as just described with respect to FIG. 5. In alternative embodiments, the sub-process A may replace steps 502 and 504 in the process 500 illustrated in FIG. 5 to provide for only one or more multiple sets of virtual bounce back coupons.

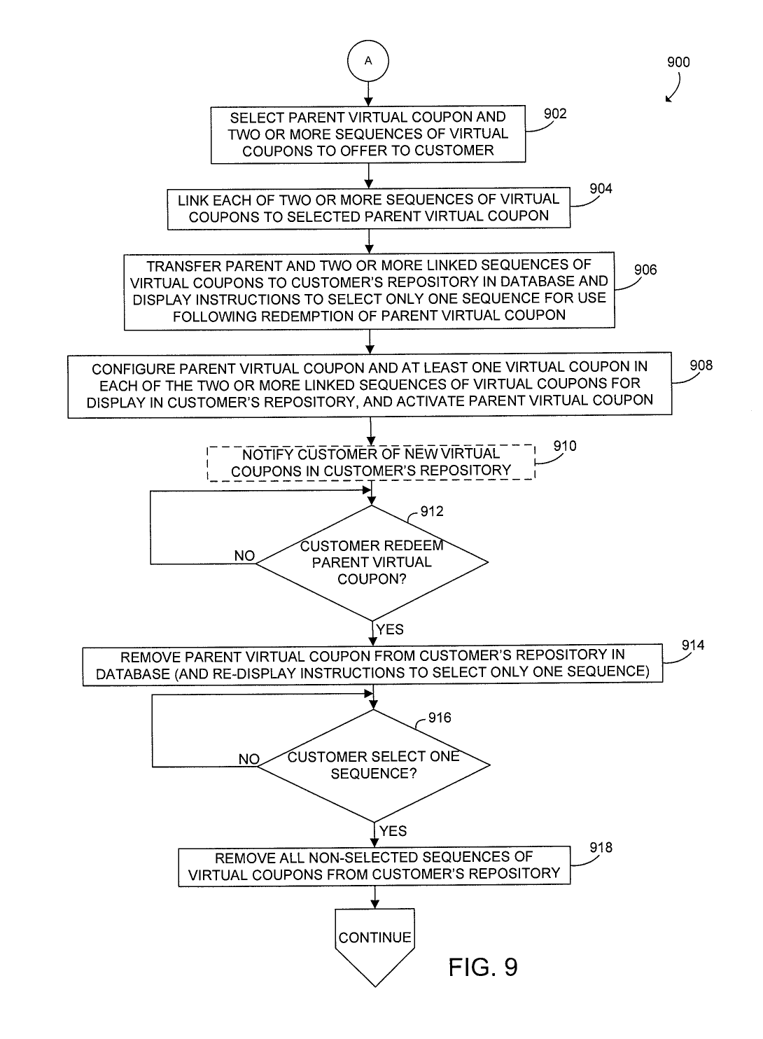

Referring now to FIG. 9, a simplified flow diagram is shown of at least one embodiment of a process 900 for selectively providing a plurality of virtual coupon sequence options for selection by a customer according to an embodiment of the routine A illustrated in FIG. 5. In one embodiment, the process 900 illustrated in FIG. 9 is stored in the memory 146 and/or data storage 148 of the main server 102 in the form of one or more sets of instructions executable by the processor 140. In alternative embodiments, some or all of the one or more sets of instructions may be stored in a memory and/or data storage of a local hub server 104, 106 and executed by a processor 120 of the local hub server 104, 106, and/or may be stored in a memory and/or data storage of a point-of-sale system 110₁-110_{K}, 110₁-110_{J} and executed by a processor 200 of the point-of-sale system 110₁-110_{K}, 110₁-110_{J}. For purposes of this disclosure, the process 900 will be described as being executed by the processor 140 of the main server 102, although it will be understood that some or all of the process 900 may alternatively be executed by a processor 120 of a local hub server 104, 106 and/or by a processor 200 of a point-of-sale system 110₁-110_{K}, 110₁-110_{J}.

The process 900 begins at step 902 where the processor 140 selects a parent virtual coupon and two or more sequences of virtual coupons to offer to a customer. Criterion or criteria for selecting the parent virtual coupon and the two or more sequences of virtual coupons may be or include any one or more of those described hereinabove with respect to step 502 of FIG. 5. Thereafter at step 904, the processor 140 is operable to link each of the two or more selected sequences of virtual coupons to the selected parent virtual coupon, e.g., such that the first virtual coupon in each of the two or more selected sequences of virtual coupons are linked directly to the parent virtual coupon. Thereafter at step 906, the processor 140 is operable to transfer the parent virtual coupon and each of the two or more linked sequences of virtual coupons to the customer's repository 406 in the server database 402. The processor 140 may be further be operable at step 906 to display instructions on the customer's repository, or to prepare instructions for display to the customer when the customer views the customer's repository 406 via a user computing device 112₁-112_{M}, to select only one of the multiple sequences of linked virtual coupons following redemption of the displayed parent virtual coupon. Thereafter at step 908, the processor 140 is operable to configure the parent virtual coupon and at least one of the virtual coupons in each of the two or more linked sequences of virtual coupons for display in the customer's repository.

Referring now to FIG. 10, a simplified block diagram is shown of an example embodiment of the customer's repository 406 within the server database 402 of the main server 102, as viewed on the display monitor 314 of the customer's user computing device 112₁-112_{M}, at a point in the process 900 just following execution of step 908. In the illustrated embodiment, the customer's repository 406 contains a single parent virtual coupon 1002 which is linked directly to the first virtual coupon 1004₁ in a first sequence 1004 of four virtual coupons 1004₁-1004₄ and also to the first virtual coupon 1006₁ in a second sequence 1006 of virtual coupons 1006₁-1006₄. The parent virtual coupon 1002 is illustrated with a solid outline to indicate that this coupon is active and is configured to be viewed by the customer when the customer's repository 406 is accessed by the customer via a user computing device 112₁-112_{M}. Each of the virtual coupons 1004₁-1004₄ are illustrated with dashed-dotted outlines to indicate that these virtual coupons 1004₁-1004₄ are configured to be visible and viewed by the customer when the contents of the customer's repository 406 are accessed by the customer, but that these virtual coupons 1004₁-1004₄ are currently inactive, i.e., non-redeemable. In contrast, only the virtual coupon 1006₄ is illustrated with dashed-dotted outline to indicate that this virtual coupon 1006₄, while inactive, is nevertheless configured to be viewed by the customer when the contents of the customer's repository 406 are accessed by the customer, whereas each of the virtual coupons 1006₁-1006₃ are illustrated with dashed outlines to indicate that these virtual coupons 1006₁-1006₃ are inactive and not configured to be viewed by the customer when the contents of the customer's repository 406 are accessed by the customer, i.e., are configured to be invisible to the customer. It will be appreciated that any one or more of the virtual coupons in any of the sequences of virtual coupons illustrated in FIGS. 6, 7 and 10 may alternatively be configured to be invisible, visible but inactive or visible and active. In the embodiment illustrated in FIG. 10, for example, since the customer will be required to choose between the sequence of virtual coupons 1004 and 1006, it may be beneficial to the customer to be able to inspect each of the virtual coupons 1004₁-1004₄ and 1006₁-1006₄ before making this selection, and in such embodiments the processor 140 may therefore be operable at step 908 of the process 900 to configure each of the virtual coupons 1004₁-1004₄ and 1006₁-1006₄ to be visible and viewed by the customer when the contents of the customer's repository 406 are accessed by the customer. In other embodiments, the last virtual coupon 1004₄ and 1006₄ in each sequence of virtual coupons 1004 and 1006 respectively may be the most valuable virtual coupon in its sequence, and before making the selection between the two sequences 1004 and 1006 of virtual coupons it may be beneficial to the customer to be able to inspect each such virtual coupon 1004₄ and 1006₄, and in such embodiments the processor 140 may therefore be operable at step 908 of the process 900 to configure each of the last virtual coupons 1004₄ and 1006₄ in the respectively sequence 1004, 1006 of virtual coupons to be visible and viewed by the customer when the contents of the customer's repository 406 are accessed by the customer.

Referring again to FIG. 9, the process 900 illustratively advances from step 908 to step 910 where the processor 140 notifies the customer of the new virtual coupon(s) in the customer's repository 406. In some alternate embodiments, step 910 may omitted from the process 900, and step 910 is outlined in FIG. 9 with a dashed-line to illustrate this feature. In embodiments which include step 910, the processor 140 is illustratively operable at step 910 to notify the customer of the new virtual coupon(s) by notifying the customer of the existence of the newly added parent virtual coupon and the two or more linked sequences of virtual coupons. In any case, the processor 140 may notify the customer at step 910 by controlling the communication module 418 to transmit a corresponding communication to the customer using any conventional notification mechanism(s)/method(s) as described above with respect to FIG. 5.

The process advances from step 910, in embodiments of the process 900 which include step 910, or from step 908 in embodiments of the process 900 which do not include step 910, to step 912 where the processor 140 is operable to determine whether the customer has redeemed the parent virtual coupon, e.g., by monitoring the process 800 or similar process. If the processor 140 determines at step 912 that the customer has not yet redeemed the parent virtual coupon, the process 900 loops back to step 912, and if the processor 140 otherwise determines at step 912 that the customer has redeemed the parent virtual coupon, the process 900 advances to step 914 where the processor 140 removes the parent virtual coupon from the customer repository 406. The processor 140 may be further operable at step 914 to re-display instructions on the customer's repository, or to re-prepare instructions for display to the customer when the customer views the customer's repository 406 via a user computing device 112₁-112_{M}, to select only one of the multiple sequences of linked virtual coupons now that the parent virtual coupon has been redeemed. Thereafter at step 916 the processor 140 is operable to determine whether the customer has selected one of the two or more sequences of virtual coupons for subsequent redemption, e.g., by monitoring the customer repository 406 for action by the customer. If the processor 140 determines at step 916 that the customer has not yet selected one of the two or more sequences of virtual coupons, the process 900 loops back to step 916, and if the processor 140 otherwise determines at step 916 that the customer has selected one of the two or more sequences of virtual coupons, the process 900 advances to step 918 where the processor 140 removes all of the non-selected sequences of virtual coupons from the customer's repository 406.

At this point in the process 900, customer selection of one of the two or more sequences of virtual coupons will leave only one sequence of virtual coupons in the customer's repository, and therefore only a single sequence of virtual coupons need to be processed. Thus, following step 918, the process 900 continues at step 506 of the process 500 where the processor 140 is operable to process the single sequence of virtual coupons according to the process steps 506-520 described above.

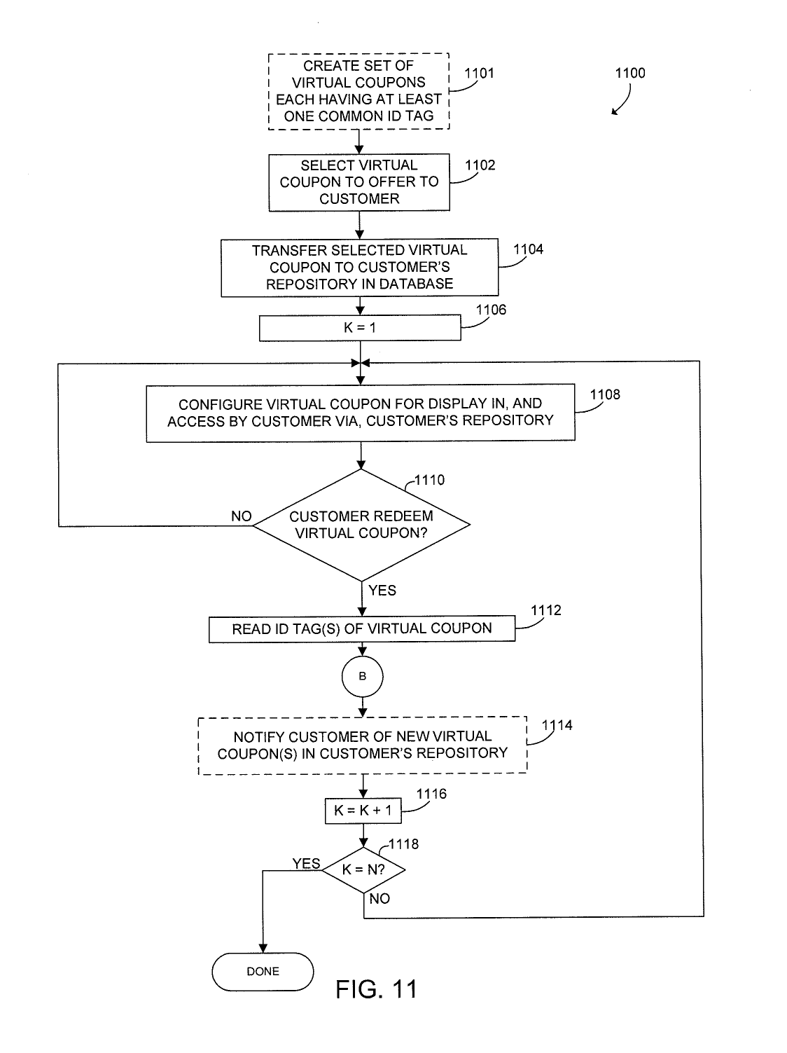

Referring now to FIG. 11, a simplified flow diagram is shown of at least one alternate embodiment of a process 1100 or selectively providing virtual bounce back coupons for customer use at a retail enterprise. In the illustrated embodiment, as an alternative to or in addition to selecting (or pre-selecting) one or more sequences of virtual coupons for transfer to a customer repository, the processor 140 may be configured according to the process 1100 to dynamically select and transfer to customer repositories virtual coupons for inclusion in one or more sequences of virtual coupons. In one embodiment, the process 1100 illustrated in FIG. 11 is stored in the memory 146 and/or data storage 148 of the main server 102 in the form of one or more sets of instructions executable by the processor 140. In alternative embodiments, some or all of the one or more sets of instructions may be stored in a memory and/or data storage of a local hub server 104, 106 and executed by a processor 120 of the local hub server 104, 106, and/or may be stored in a memory and/or data storage of a point-of-sale system 110₁-110_{K}, 110₁-110_{J} and executed by a processor 200 of the point-of-sale system 110₁-110_{K}, 110₁-110_{J}. For purposes of this disclosure, the process 1100 will be described as being executed by the processor 140 of the main server 102, although it will be understood that some or all of the process 1100 may alternatively be executed by a processor 120 of a local hub server 104, 106 and/or by a processor 200 of a point-of-sale system 110₁-110_{K}, 110₁-110_{J}.

The process 1100 begins at step 1102 where the processor 140 selects a virtual coupon to offer to a customer. Criterion or criteria for selecting the parent virtual coupon and the two or more sequences of virtual coupons may be or include any one or more of those described hereinabove with respect to step 502 of FIG. 5. In one embodiment, the processor 140 is operable to execute step 1102 be selecting the virtual coupon from the total pool of virtual coupons stored in the virtual coupon database 408. In alternative embodiments, the process 1100 may include a step 1101 that is executed prior to step 1102 in which the processor 140 creates a set of virtual coupons each having at least one common ID tag to form a subset or collection of virtual coupons from which to select at step 1102. Illustratively, each of the virtual coupons stored in the virtual coupon database 408 may include one or more identification (ID) tags identifying one or more corresponding categories and/or families of virtual coupons to which the virtual coupon belongs. For example, a virtual coupon for flour may have a number of tags identifying flour as belonging to the categories of, for example, bread, desserts, and pasta. In any case, such virtual coupon ID tags may provide one basis for dynamically generating virtual coupons which the processor 140 can bounce back to customers as they redeem their current virtual coupons. Those skilled in the art will recognize other bases for dynamically generating virtual coupons, including randomly selecting virtual coupons, and any such bases are contemplated by this disclosure.

Following step 1102, the process 1100 advances through steps 1104-1110 which are substantially similar to steps 504-508 and 514 of the process 500 illustrated in FIG. 5, and following the “YES” branch of step 1100 the process 1100 advances to step 112 where the processor 140 is operable to read the one or more virtual coupon ID tags of the virtual coupon being redeemed. Thereafter the process 1100 advances to a sub-process B.

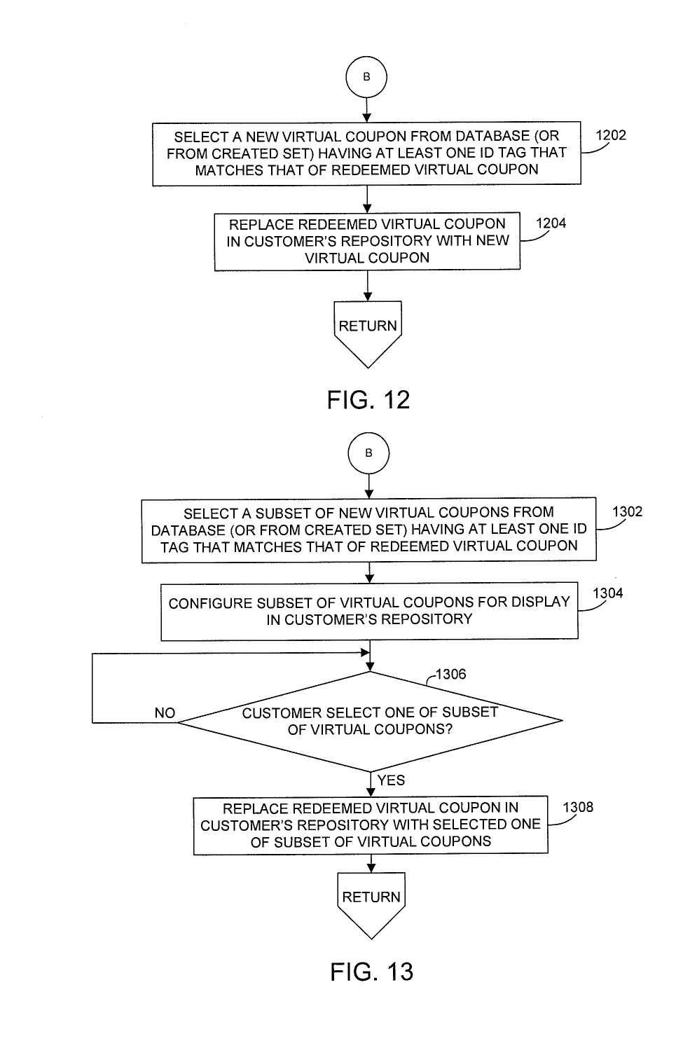

Referring to FIG. 12, a simplified flow diagram is shown of one embodiment of the sub-process B illustrated in the process 1100 of FIG. 11. The sub-process B illustrated in FIG. 12 begins at step 1202 where the processor 140 selects a new virtual coupon from the virtual coupon database 408, or from a created set of virtual coupons, e.g., created at step 1101 of the process illustrated in FIG. 11, which has at least one ID tag that matches that of the just-redeemed virtual coupon. Thereafter at step 1204, the processor 140 is operable to replace the redeemed virtual coupon in the customer's repository with the new virtual coupon selected at step 1202. In this manner, virtual coupons dynamically selected for bounce back to customers are related by one or more virtual coupon ID tags to thereby provide some amount of continuity in the virtual coupons being offered to customers.

Referring now to FIG. 13, a simplified flow diagram is shown of an alternate embodiment of the sub-process B illustrated in the process 1100 of FIG. 11. The sub-process B illustrated in FIG. 13 begins at step 1302 where the processor 140 selects a subset of new virtual coupons from the virtual coupon database 408, or from a created set of virtual coupons, e.g., created at step 1101 of the process illustrated in FIG. 11, each of which has at least one ID tag that matches that of the just-redeemed virtual coupon. Thereafter at step 1304, the processor 140 is operable to configure the each virtual coupon in the subset of virtual coupons selected at step 1202 for display, or at least partial display, in the customer's repository. Thereafter at step 1306, the processor 140 is operable to determine whether the customer has selected one of the subset of virtual coupons offered to the customer. If not the sub-process illustrated in FIG. 13 loops back to step 1306, and if so the sub-process advances to step 1308 where the processor 140 is operable to replace the redeemed virtual coupon in the customer's repository with the selected one of the subset of virtual coupons.

Referring again to FIG. 11, the process 100 advances from the sub-process B through steps 1114-1118 which are substantially similar to steps 510 and 518-520 of the process 500 illustrated in FIG. 5.

It will be understood that any single feature of any embodiment of the virtual coupon bounce back embodiments illustrated and described herein may be implemented in any of the other embodiments regardless of whether or not explicitly described with respect to that embodiment. It will be further understood that not every feature described with respect to one embodiment need be implemented with that embodiment, as some features may be optional regardless of whether explicitly stated in the above description.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, while the concepts illustrated and described herein have been illustrated and described in the context of purchasing items at a point-of-sale system that is physically located at a retail outlet of the business enterprise, it will be understood that bounce back coupons of any type and/or configuration described herein may alternatively or additionally be redeemed at a website of the business enterprise as part of an on-line purchase transaction.

What is claimed is:

1. A system for providing virtual coupons to a customer, the system comprising:
a database having a plurality of virtual coupons stored therein,
a virtual coupon repository associated with the customer, and
a virtual coupon module to transfer a sequence of selected ones of the plurality of virtual coupons stored in the database to the virtual coupon repository, and to sequentially activate for redemption by the customer each successive virtual coupon in the sequence after a preceding virtual coupon in the sequence has been redeemed by the customer.

2. The system of claim 1 wherein each of the database, the virtual coupon repository and the virtual coupon module is contained within or accessible by a server operated by a retail enterprise, the server to control operation of the virtual coupon module.

3. The system of claim 1 wherein the virtual coupon module to sequentially activate for redemption by the customer each virtual coupon in the sequence by activating a first virtual coupon in the sequence for redemption by the customer during or following transfer of the sequence of the selected ones of the plurality of virtual coupons stored in the database to the virtual coupon repository, and thereafter by sequentially activating for redemption by the customer a next successive virtual coupon in the sequence following redemption by the customer of a preceding virtual coupon in the sequence.

4. The system of claim 1 wherein the virtual coupon module to notify the customer upon or following activation of at least one of the virtual coupons in the sequence by the virtual coupon module.

5. The system of claim 1 further comprising a user computing device having a processor coupled to a display monitor and to a memory having stored therein instructions executable by the processor to control the display monitor to display thereon each of the sequence of selected ones of the plurality of virtual coupons contained in the virtual coupon repository that are configured to be displayed to the customer.

6. The system of claim 5 wherein the virtual coupon module to configure a currently active one of the sequence of selected ones of the plurality of virtual coupons contained in the virtual coupon repository to be displayed to the customer as an active and redeemable coupon.

7. The system of claim 6 wherein the virtual coupon module to configure remaining ones of the sequence of selected ones of the plurality of virtual coupons contained in the virtual coupon repository to be one of displayed to the customer as inactive and not redeemable and hidden from display to the customer.

8. The system of claim 6 wherein the virtual coupon module to delete each virtual coupon in the sequence from the virtual coupon repository after redemption thereof by the customer.

9. The system of claim 8 wherein the virtual coupon module to configure remaining ones of the sequence of selected ones of the plurality of virtual coupons contained in the virtual coupon repository to be one of displayed to the customer as inactive and not yet redeemable and hidden from display to the customer.

10. The system of claim 1 further comprising a point-of-sale system having a processor coupled to a memory having stored therein instructions executable by the processor to process one or more items selected for purchase by the customer, to compare a currently active one of the sequence of selected ones of the plurality of virtual coupons contained in the virtual coupon repository with the one or more items selected for purchase by the customer and to redeem the currently active one of the virtual coupons contained in the virtual coupon repository if the currently active one of the virtual coupons contained in the virtual coupon repository matches one of the one or more items selected for purchase by the customer.

11. The system of claim 1 wherein the sequence of selected ones of the plurality of virtual coupons transferred to the virtual coupon repository defines a first sequence of virtual coupons,
and wherein the virtual coupon module to transfer a selected parent virtual coupon from the plurality of virtual coupons stored in the database to the virtual coupon repository, to transfer a second sequence of selected ones of the plurality of virtual coupons stored in the database to the virtual coupon repository, and to link the parent virtual coupon in the virtual coupon repository to first virtual coupons in each of the first and second sequences of virtual coupons,
and wherein the virtual coupon module to initially activate for redemption only the parent virtual coupon.

12. The system of claim 11 wherein the virtual coupon module to activate for redemption the first virtual coupon in one of the first and second sequences of virtual coupons selected by the customer following redemption of the parent virtual coupon by the customer,
and wherein the virtual coupon module to sequentially activate for redemption by the customer each virtual coupon in the one of the first and second sequences selected by the customer after a preceding virtual customer coupon in the one of the first and second selected sequences selected by the customer has been redeemed by the customer.

13. The system of claim 12 wherein the virtual coupon module to delete from the virtual coupon repository the one of the first and second sequences of virtual coupons not selected by the customer following redemption of the parent virtual coupon by the customer.

14. The system of claim 11 further comprising a user computing device having a processor coupled to a display monitor and to a memory having stored therein instructions executable by the processor to control the display monitor to display thereon each virtual coupon contained in the virtual coupon repository that is configured to be displayed to the customer,
wherein the virtual coupon module to configure the parent virtual coupon to be displayed to the customer as an active and redeemable coupon and to configure at least the first virtual coupons in each of the first and second sequences of virtual coupons to be displayed to the customer, when or after the parent virtual coupon is initially activated for redemption.

15. The system of claim 14 wherein the virtual coupon module to display instructions in the virtual coupon repository, at least one of following initial activation of the virtual parent coupon for redemption and following redemption by the customer of the virtual parent coupon, to select one of the first and second sequences of virtual coupons to be sequentially redeemed by the customer following redemption of the parent virtual coupon by the customer,
and wherein, following customer selection of the one of the first and second sequences of virtual coupons, the virtual coupon module to activate the first virtual coupon in the customer selected one of the first and second sequences of virtual coupons for subsequent redemption by the customer, to configure the first virtual coupon in the customer selected one of the first and second sequences of virtual coupons to be displayed to the customer as an active and redeemable virtual coupon, and to sequentially activate for redemption by the customer and configure to be displayed to the customer as an active and redeemable virtual coupon each successive virtual coupon in the customer selected one of the first and second sequences of virtual coupons after a preceding virtual customer coupon in the customer selected one of the first and second selected sequences of virtual coupons has been redeemed by the customer.

16. The system of claim 15 wherein, following customer redemption of the one of the first and second sequences of virtual coupons, the virtual coupon module to delete the other of the first and second sequences of virtual coupons from the virtual coupon repository.

17. A method of providing virtual coupons to a customer, the method comprising:
transferring a sequence of selected ones of a plurality of virtual coupons stored in a database to a virtual coupon repository, and
sequentially activating for redemption by the customer each successive virtual coupon in the sequence after a preceding virtual coupon in the sequence has been redeemed by the customer.

18. The method of claim 17 wherein sequentially activating for redemption by the customer each virtual coupon in the sequence comprises activating a first virtual coupon in the sequence for redemption by the customer during or following transfer of the sequence of the selected ones of the plurality of virtual coupons stored in the database to the virtual coupon repository, and
thereafter sequentially activating for redemption by the customer a next successive virtual coupon in the sequence following redemption by the customer of a preceding virtual coupon in the sequence.

19. The method of claim 17 wherein the virtual coupon module to configure a currently active one of the sequence of selected ones of the plurality of virtual coupons contained in the virtual coupon repository to be displayed to the customer as an active and redeemable coupon, and to configure remaining ones of the sequence of selected ones of the plurality of virtual coupons contained in the virtual coupon repository to be one of displayed to the customer as inactive and not redeemable and hidden from display to the customer.

20. The method of claim 17 further comprising deleting each virtual coupon in the sequence from the virtual coupon repository after redemption thereof by the customer.

21. A system for providing virtual coupons to a customer, the system comprising:
a database having a plurality of virtual coupons stored therein, each of the plurality of virtual coupons having one or more identification tags,
a virtual coupon repository associated with the customer, and
a virtual coupon module to transfer a selected one of the plurality of virtual coupons stored in the database to the virtual coupon repository for redemption by the customer, and to replace the selected one of the plurality of virtual coupons in the virtual coupon repository with one of the remaining virtual coupons in the plurality of virtual coupons following redemption by the customer of the selected one of the plurality of virtual coupons, the one of the remaining virtual coupons having at least one identification tag in common with at least one identification tag of the selected one of the plurality of virtual coupons.

22. The system of claim 21 wherein the virtual coupon module to repeatedly replace a current one of the plurality of virtual coupons in the virtual coupon repository with another one of the remaining virtual coupons following redemption by the customer of the current one of the plurality of virtual coupons, the another one of the remaining virtual coupons having at least one identification tag in common with at least one identification tag of the current one of the plurality of virtual coupons.

23. The system of claim 22 wherein the virtual coupon module, in at least one replacement of the current one of the plurality of virtual coupons, to replace the current one of plurality of virtual coupons in the virtual coupon repository with another one of the remaining virtual coupons by transferring a subset of the remaining virtual coupons into the virtual coupon repository following redemption by the customer of the current one of the plurality of virtual coupons, and replacing the current one of plurality of virtual coupons in the virtual coupon repository with a selected one of the subset of the remaining virtual coupons.

24. The system of claim 21 wherein the plurality of virtual coupons defines a set of virtual coupons each having in common at least one of the one or more identification tags,
wherein the virtual coupon module to transfer the selected one of the plurality of virtual coupons to the virtual coupon repository by transferring a selected one of the set of virtual coupons into the virtual coupon repository,
and wherein the virtual coupon module to replace the selected one of the plurality of virtual coupons in the virtual coupon repository by replacing the selected one of the set of virtual coupons in the virtual coupon repository with one of the remaining virtual coupons in the set of virtual coupons following redemption by the customer of the selected one of the set of virtual coupons.

25. The system of claim 24 wherein the virtual coupon module to repeatedly replace a current one of set of virtual coupons in the virtual coupon repository with another one of the remaining virtual coupons in the set of virtual coupons following redemption by the customer of the current one of the set of virtual coupons.

26. The system of claim 25 wherein the virtual coupon module to replace the current one of the set of virtual coupons in the virtual coupon repository with another one of the remaining virtual coupons in the set of virtual coupons by transferring a subset of the set of virtual coupons into the virtual coupon repository following redemption by the customer of the current one of the set of virtual coupons, and replacing the current one of set of virtual coupons in the virtual coupon repository with a selected one of the subset of the remaining virtual coupons in the set of virtual coupons.

27. A method of providing virtual coupons to a customer, the method comprising:
transferring a selected one of a plurality of virtual coupons stored in a database to a virtual coupon repository for redemption by the customer, each of the plurality of virtual coupons having one or more identification tags, and
replacing the selected one of the plurality of virtual coupons in the virtual coupon repository with one of the remaining virtual coupons in the plurality of virtual coupons following redemption by the customer of the selected one of the plurality of virtual coupons, the one of the remaining virtual coupons having at least one identification tag in common with at least one identification tag of the selected one of the plurality of virtual coupons.

28. The method of claim 27 further comprising repeatedly replacing a current one of the plurality of virtual coupons in the virtual coupon repository with another one of the remaining virtual coupons following redemption by the customer of the current one of the plurality of virtual coupons, the another one of the remaining virtual coupons having at least one identification tag in common with at least one identification tag of the current one of the plurality of virtual coupons.

29. The method of claim 28 wherein at least one instance of replacing the current one of plurality of virtual coupons in the virtual coupon repository with another one of the remaining virtual coupons comprises:
transferring a subset of the remaining virtual coupons into the virtual coupon repository following redemption by the customer of the current one of the plurality of virtual coupons, and
replacing the current one of plurality of virtual coupons in the virtual coupon repository with a selected one of the subset of the remaining virtual coupons.

30. The method of claim 27 wherein the plurality of virtual coupons defines a set of virtual coupons each having in common at least one of the one or more identification tags,
and wherein transferring the selected one of the plurality of virtual coupons to the virtual coupon repository comprises transferring a selected one of the set of virtual coupons into the virtual coupon repository,
and wherein replacing the selected one of the plurality of virtual coupons in the virtual coupon repository comprises replacing the selected one of the set of virtual coupons in the virtual coupon repository with one of the remaining virtual coupons in the set of virtual coupons following redemption by the customer of the selected one of the set of virtual coupons.
